(19) United States
(12) Patent Application Publication
(10) Pub. No.: US 2024/0430786 A1
(43) Pub. Date: Dec. 26, 2024

(54) ON-DEMAND SYSTEM INFORMATION FOR FLEXIBLE CELLS

(71) Applicant: QUALCOMM Incorporated, San Diego, CA (US)

(72) Inventors: Hung Dinh LY, San Diego, CA (US); Kexin XIAO, Shanghai (CN); Krishna Kiran MUKKAVILLI, San Diego, CA (US)

(21) Appl. No.: 18/708,052

(22) PCT Filed: Jan. 25, 2022
(86) PCT No.: PCT/CN2022/073689

§ 371 Date: May 7, 2024

(51) Int. Cl. H04W 48/14; H04W 72/02; H04W 74/0833

(52) U.S. Cl. CPC H04W 48/14; H04W 72/02; H04W 74/0833

(57) ABSTRACT

Methods, systems, and devices for wireless communications are described. In a wireless communications system, a base station may support a flexible cell with a set of carriers including an anchor carrier and two or more non-anchor carriers. In some examples, a user equipment (UE) may select, from among the set of carriers and based on receiving an indication of the configuration, a carrier for transmission of a request for system information associated with the flexible cell. The UE may transmit the request for system information to the base station via the selected carrier. Additionally or alternatively, the UE may select a carrier for reception by the UE of an acknowledgement for the request for the system information, and the UE may receive the acknowledgement for the request for system information via the selected carrier.

### CROSS REFERENCE

The present application is a 371 national phase filing of International PCT Application No. PCT/CN2022/073689 by LY et al., entitled “ON-DEMAND SYSTEM INFORMATION FOR FLEXIBLE CELLS,” filed Jan. 25, 2022, which is assigned to the assignee hereof, and which is expressly incorporated by reference in its entirety herein.

### FIELD OF TECHNOLOGY

The following relates to wireless communications, including on-demand system information for flexible cells.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, a base station may support a flexible cell including multiple carriers, and may communicate with a UE via one or more carriers. Techniques for selecting carriers for particular communications may be improved.

### SUMMARY

The described techniques relate to improved methods, systems, devices, and apparatuses that support on-demand system information for flexible cells. Generally, the described techniques provide for a user equipment (UE) to select one or more carriers of a flexible cell for uplink transmission and downlink reception in an on-demand system information procedure. In some cases, a base station may support a flexible cell configured with a set of carriers including an anchor carrier and two or more non-anchor carriers. A UE may select a carrier from the set of carriers for transmission of a request for system information with the flexible cell, and the UE may transmit the request for the system information via the selected carrier. In some examples, the carrier may be selected for the transmission of the request based on a carrier identifier, a reference signal measurement, or any combination thereof. Additionally or alternatively, the UE may select a carrier from the set of carriers for reception of an acknowledgement for the request for system information, where the carrier may be the same or different from the carrier selected for the transmission of the request. In some examples, the UE may receive the acknowledgement for the request for system information from the base station via the selected carrier. In some examples, the carrier for reception of the acknowledgement may be selected for the reception of the acknowledgement based on control message, a shared channel message, a random access preamble, or any combination thereof.

A method for wireless communication at a UE is described. The method may include receiving an indication of a configuration for a flexible cell supported by a base station, where the flexible cell includes a set of carriers including an anchor carrier and two or more non-anchor carriers, selecting, from among the set of carriers of the flexible cell and based on the configuration for the flexible cell, a carrier for transmission of a request for system information associated with the flexible cell, and transmitting the request for the system information via the selected carrier.

An apparatus for wireless communication at a UE is described. The apparatus may include memory, a transceiver, and at least one processor of a UE, the at least one processor coupled with the memory and the transceiver. The at least one processor may be configured to cause the apparatus to receive, via the transceiver, an indication of a configuration for a flexible cell supported by a base station, where the flexible cell includes a set of carriers including an anchor carrier and two or more non-anchor carriers, select, from among the set of carriers of the flexible cell and based on the configuration for the flexible cell, a carrier for transmission of a request for system information associated with the flexible cell, and transmit, via the transceiver, the request for the system information via the selected carrier.

Another apparatus for wireless communication at a UE is described. The apparatus may include means for receiving an indication of a configuration for a flexible cell supported by a base station, where the flexible cell includes a set of carriers including an anchor carrier and two or more non-anchor carriers, means for selecting, from among the set of carriers of the flexible cell and based on the configuration for the flexible cell, a carrier for transmission of a request for system information associated with the flexible cell, and means for transmitting the request for the system information via the selected carrier.

A non-transitory computer-readable medium storing code for wireless communication at a UE is described. The code may include instructions executable by a processor to receive an indication of a configuration for a flexible cell supported by a base station, where the flexible cell includes a set of carriers including an anchor carrier and two or more non-anchor carriers, select, from among the set of carriers of the flexible cell and based on the configuration for the flexible cell, a carrier for transmission of a request for system information associated with the flexible cell, and transmit the request for the system information via the selected carrier.

In some examples of the method, apparatuses, and non-transitory computer-readable medium described herein, receiving the indication of the configuration for the flexible cell may include operations, features, means, or instructions for receiving an indication of a set of carrier identifiers including a respective carrier identifier for each carrier of the set of carriers and receiving an indication of the respective carrier identifier for the selected carrier, where the indication of the respective carrier identifier for the selected carrier indicates which carrier the UE may be to select for transmission of the request for the system information.

In some examples of the method, apparatuses, and non-transitory computer-readable medium described herein, receiving the indication of the configuration for the flexible cell may include operations, features, means, or instructions for receiving radio resource control (RRC) signaling that indicates the set of carrier identifiers, the respective carrier identifier for the selected carrier, or both.

In some examples of the method, apparatuses, and non-transitory computer-readable medium described herein, receiving the indication of the set of carrier identifiers may include operations, features, means, or instructions for receiving system information that indicates the set of carrier identifiers, the respective carrier identifier for the selected carrier, or both.

Some examples of the method, apparatuses, and non-transitory computer-readable medium described herein may further include operations, features, means, or instructions for receiving a reference signal from the base station and measuring a received power level for the reference signal, where selecting the carrier based on the configuration for the flexible cell includes selecting the carrier for transmission of the request for the system information based on the received power level for the reference signal.

Some examples of the method, apparatuses, and non-transitory computer-readable medium described herein may further include operations, features, means, or instructions for comparing the received power level for the reference signal to one or more thresholds, where receiving the indication of the configuration for the flexible cell comprises receiving an indication of the one or more thresholds, and where selecting the carrier for transmission of the request for the system information may be based on the comparing.

In some examples of the method, apparatuses, and non-transitory computer-readable medium described herein, the one or more thresholds includes a single threshold and the method, apparatuses, and non-transitory computer-readable medium may include further operations, features, means, or instructions for using the single threshold to select one of the two or more non-anchor carriers to use as a supplemental uplink (SUL) carrier.

In some examples of the method, apparatuses, and non-transitory computer-readable medium described herein, the set of carriers includes a set of multiple subsets of one or more carriers, the set of multiple subsets corresponding to a set of multiple received power ranges that may be each delimited by at least one threshold of the one or more thresholds, comparing the received power level for the reference signal to the one or more thresholds includes determining that the received power level for the reference signal may be within a first received power range of the set of multiple received power ranges, and selecting the carrier for transmission of the request for the system information includes selecting the carrier from a first subset of carriers based on the first subset of carriers corresponding to the first received power range.

In some examples of the method, apparatuses, and non-transitory computer-readable medium described herein, selecting the carrier from the first subset of carriers may include operations, features, means, or instructions for selecting a first carrier based on the first carrier being associated with a lowest carrier identifier from among one or more carrier identifiers corresponding to the first subset of carriers.

In some examples of the method, apparatuses, and non-transitory computer-readable medium described herein, the first carrier may be lower in frequency than each other carrier in the first subset of carriers.

In some examples of the method, apparatuses, and non-transitory computer-readable medium described herein, transmitting the request for the system information may include operations, features, means, or instructions for transmitting a random access preamble via the selected carrier, where the random access preamble may be one of a set of random access preambles each corresponding to a respective set of system information associated with the flexible cell, and where the request for system information associated with the flexible cell includes a request for the respective set of system information corresponding to the transmitted random access preamble.

A method for wireless communication at a UE is described. The method may include receiving an indication of a configuration for a flexible cell supported by a base station, where the flexible cell includes a set of carriers including an anchor carrier and two or more non-anchor carriers, selecting, from among the set of carriers of the flexible cell and based on the configuration for the flexible cell, a carrier for reception by the UE of an acknowledgement for a request for system information associated with the flexible cell, transmitting, to the base station, the request for the system information associated with the flexible cell, and receiving the acknowledgement for the request for the system information via the selected carrier.

An apparatus for wireless communication at a UE is described. The apparatus may include memory, a transceiver, and at least one processor of a UE, the at least one processor coupled with the memory and the transceiver. The at least one processor may be configured to cause the apparatus to receive, via the transceiver, an indication of a configuration for a flexible cell supported by a base station, where the flexible cell includes a set of carriers including an anchor carrier and two or more non-anchor carriers, select, from among the set of carriers of the flexible cell and based on the configuration for the flexible cell, a carrier for reception by the UE of an acknowledgement for a request for system information associated with the flexible cell, transmit, via the transceiver and to the base station, the request for the system information associated with the flexible cell, and receive, via the transceiver, the acknowledgement for the request for the system information via the selected carrier.

Another apparatus for wireless communication at a UE is described. The apparatus may include means for receiving an indication of a configuration for a flexible cell supported by a base station, where the flexible cell includes a set of carriers including an anchor carrier and two or more non-anchor carriers, means for selecting, from among the set of carriers of the flexible cell and based on the configuration for the flexible cell, a carrier for reception by the UE of an acknowledgement for a request for system information associated with the flexible cell, means for transmitting, to the base station, the request for the system information associated with the flexible cell, and means for receiving the acknowledgement for the request for the system information via the selected carrier.

A non-transitory computer-readable medium storing code for wireless communication at a UE is described. The code may include instructions executable by a processor to receive an indication of a configuration for a flexible cell supported by a base station, where the flexible cell includes a set of carriers including an anchor carrier and two or more non-anchor carriers, select, from among the set of carriers of the flexible cell and based on the configuration for the flexible cell, a carrier for reception by the UE of an acknowledgement for a request for system information associated with the flexible cell, transmit, to the base station, the request for the system information associated with the flexible cell, and receive the acknowledgement for the request for the system information via the selected carrier.

In some examples of the method, apparatuses, and non-transitory computer-readable medium described herein, receiving the indication of the configuration for the flexible cell may include operations, features, means, or instructions for receiving, prior to selecting the carrier, additional system information that indicates the configuration for the flexible cell.

In some examples of the method, apparatuses, and non-transitory computer-readable medium described herein, the additional system information includes an indication of a carrier identifier for the selected carrier.

In some examples of the method, apparatuses, and non-transitory computer-readable medium described herein, an absence from the additional system information of an indication of a carrier identifier for the selected carrier includes an indication that the UE may be to select the anchor carrier as the selected carrier.

In some examples of the method, apparatuses, and non-transitory computer-readable medium described herein, receiving the acknowledgement for the request for the system information via the selected carrier may include operations, features, means, or instructions for receiving a control message via the selected carrier and receiving a shared channel message via the selected carrier, the shared channel message scheduled by the control message and including the acknowledgement.

In some examples of the method, apparatuses, and non-transitory computer-readable medium described herein, receiving the indication of the configuration for the flexible cell may include operations, features, means, or instructions for receiving a first indication of a first carrier of the set of carriers, where the first carrier may be for receiving a control message, and the method, apparatuses, and non-transitory computer-readable medium described herein may further include operations, features, means, or instructions for receiving a second indication of a second carrier of the set of carriers, where the second carrier is the selected carrier and may be for receiving a shared channel message that may be scheduled by the control message and includes the acknowledgement.

In some examples of the method, apparatuses, and non-transitory computer-readable medium described herein, receiving the indication of the configuration for the flexible cell may include operations, features, means, or instructions for receiving, prior to selecting the carrier, additional system information that includes the first indication of the first carrier and the second indication of the second carrier.

In some examples of the method, apparatuses, and non-transitory computer-readable medium described herein, receiving the indication of the configuration for the flexible cell may include operations, features, means, or instructions for receiving, prior to selecting the carrier, additional system information that includes the first indication of the first carrier and receiving the second indication of the second carrier within the control message.

In some examples of the method, apparatuses, and non-transitory computer-readable medium described herein, the first carrier may be different than the second carrier.

In some examples of the method, apparatuses, and non-transitory computer-readable medium described herein, the first carrier and the second carrier are a same carrier.

In some examples of the method, apparatuses, and non-transitory computer-readable medium described herein, receiving the indication of the configuration for the flexible cell may include operations, features, means, or instructions for receiving an indication of a set of random access preambles for the UE to use for transmitting system information requests.

In some examples of the method, apparatuses, and non-transitory computer-readable medium described herein, the request for the system information associated with the flexible cell may be transmitted using a preamble of the set of random access preambles, and the method, apparatuses, and non-transitory computer-readable medium described herein may further include operations, features, means, or instructions for receiving the system information associated with the flexible cell via a second carrier of the set of carriers, where the acknowledgement for the request includes medium access control (MAC) signaling that indicates the second carrier.

Some examples of the method, apparatuses, and non-transitory computer-readable medium described herein may further include operations, features, means, or instructions for receiving, after receiving the acknowledgement for the request via the selected carrier, the system information associated with the flexible cell via the selected carrier.

Some examples of the method, apparatuses, and non-transitory computer-readable medium described herein may further include operations, features, means, or instructions for receiving, prior to transmitting the request for the system information associated with the flexible cell, a first system information block (SIB) via a second carrier of the set of carriers and receiving, after receiving the acknowledgement for the request via the selected carrier, the system information associated with the flexible cell via the second carrier.

Some examples of the method, apparatuses, and non-transitory computer-readable medium described herein may further include operations, features, means, or instructions for receiving, prior to transmitting the request for the system information associated with the flexible cell, a synchronization signal block (SSB) via a second carrier of the set of carriers and receiving, after receiving the acknowledgement for the request via the selected carrier, the system information associated with the flexible cell via the second carrier.

Some examples of the method, apparatuses, and non-transitory computer-readable medium described herein may further include operations, features, means, or instructions for transmitting the request for the system information includes transmitting a random access preamble and receiving the acknowledgement for the request for the system information includes receiving a random access response (RAR) message in response to transmitting the random access preamble.

### BRIEF DESCRIPTION OF THE DRAWINGS

FIG. 1 illustrates an example of a wireless communications system that supports on-demand system information for flexible cells in accordance with aspects of the present disclosure.

FIG. 2 illustrates an example of a wireless communications system that supports on-demand system information for flexible cells in accordance with aspects of the present disclosure.

FIGS. 3 through 5 illustrate examples of process flows that support on-demand system information for flexible cells in accordance with aspects of the present disclosure.

FIGS. 6 and 7 show block diagrams of devices that support on-demand system information for flexible cells in accordance with aspects of the present disclosure.

FIG. 8 shows a block diagram of a communications manager that supports on-demand system information for flexible cells in accordance with aspects of the present disclosure.

FIG. 9 shows a diagram of a system including a device that supports on-demand system information for flexible cells in accordance with aspects of the present disclosure.

FIGS. 10 through 16 show flowcharts illustrating methods that support on-demand system information for flexible cells in accordance with aspects of the present disclosure.

### DETAILED DESCRIPTION

A base station may include or support a flexible cell (e.g., an elastic cell), which may be a cell with a collection of multiple carriers. A set of carriers of the flexible cell may include an anchor carrier and one or more non-anchor carriers. For example, the flexible cell may include an anchor carrier, a first non-anchor carrier, and a second non-anchor carrier. Other examples of a flexible cell may include any quantity of carriers (e.g., one anchor carrier and one or more non-anchor carriers, such as one non-anchor carrier or three or more non-anchor carriers).

In some cases, system information (e.g., on-demand system information) may be communicated between the base station and a user equipment (UE) via any carrier (e.g., the anchor carrier or a non-anchor carrier) of the flexible cell. For example, the base station may transmit system information (e.g., on-demand system information) to the UE based on receiving a request for system information from the UE. Because multiple carriers (e.g., an anchor carrier and up to N non-anchor carriers) may be available for communications on the flexible cell, including for system information, the UE may need to determine (e.g., select) which carrier to use for transmission of a request for system information, for example whether to use a non-anchor carrier (and if so, which one) or the anchor carrier. Additionally or alternatively, the UE may need to determine (e.g., select) which carrier to use (e.g., monitor) for reception of signaling from the base station that is responsive to a request for system information, such as an acknowledgement of the request for system information or the requested system information.

Techniques described herein provide for a UE to select one or more carriers of a flexible cell for uplink transmission and downlink reception in an on-demand system information procedure. In some cases, a base station may support a flexible cell configured with a set of carriers including an anchor carrier and two or more non-anchor carriers. A UE may select a carrier from the set of carriers for transmission of a request for system information with the flexible cell, and the UE may transmit the request for the system information via the selected carrier. In some examples, the carrier may be selected for the transmission of the request based on a carrier identifier, a reference signal measurement, or any combination thereof. Additionally or alternatively, the UE may select a carrier from the set of carriers for reception of an acknowledgement for the request for system information, where the carrier may be the same or different from the carrier selected for the transmission of the request.

The UE may receive the acknowledgement for the request for system information from the base station via the selected carrier. In some examples, the carrier for reception of the acknowledgement may be selected for the reception of the acknowledgement based on control message, a shared channel message, a random access preamble, or any combination thereof. Additionally or alternatively, the UE may select a carrier from the set of carriers for reception of the system information that is requested by a request for system information, where the carrier may be the same or different from the carrier selected for the transmission of the request and may be the same or different from the carrier selected for the reception of the acknowledgement of the request. In some examples, the UE may transmit the request for the system information using a random access preamble. The UE may receive the acknowledgement for the request which may include medium access control (MAC) signaling indicating a carrier for reception of the requested system information by the UE. Additionally or alternatively, if the base station fails to explicitly indicate a carrier selected for reception of the requested system information by the UE, the UE may receive the requested system information via the same carrier on which the UE received the acknowledgement, a system information block (SIB), or a synchronization signal block (SSB).

Aspects of the disclosure are initially described in the context of wireless communications systems. Aspects of the disclosure are then described in the context of process flows. Aspects of the disclosure are further illustrated by and described with reference to apparatus diagrams, system diagrams, and flowcharts that relate to on-demand system information for flexible cells.

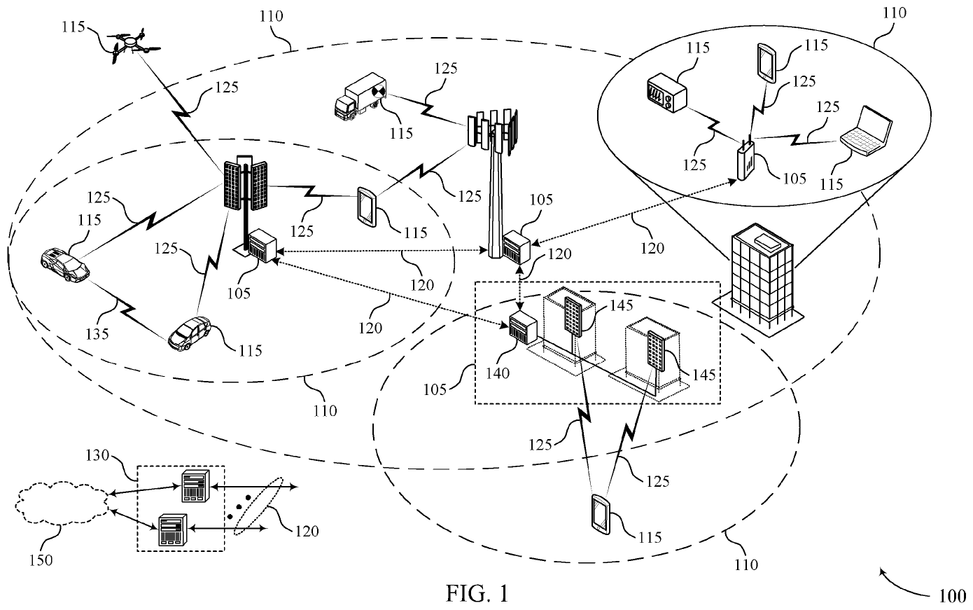

FIG. 1 illustrates an example of a wireless communications system 100 that supports on-demand system information for flexible cells in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a ULE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ−N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, in some examples, in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

A base station 105 may include or support a flexible cell (e.g., an elastic cell), which may be a cell with a collection of multiple carriers (e.g., any combination of carriers). A set of carriers of the flexible cell may include an anchor carrier and one or more non-anchor carriers. For example, the flexible cell may include an anchor carrier, a first non-anchor carrier, and a second non-anchor carrier. Other examples of a flexible cell may include any quantity of carriers (e.g., one anchor carrier and one or more non-anchor carriers, such as one non-anchor carrier or three or more non-anchor carriers). In some examples, the carriers in the flexible cell may include any combination of carriers for FDD operations, TDD operations, and supplemental uplink (SUL) operations, which may enable flexible use of different carriers in NR communications. For example, the flexible cell may include a non-anchor carrier 1 (e.g., 1.8 gigahertz (GHz) FDD), an anchor carrier (e.g., 2.6 GHz TDD) and a non-anchor carrier 2 (e.g., 2.3 GHz SUL), where the anchor carrier may operate at a higher frequency than the non-anchor carriers. In some examples, the carriers in the flexible cell may be non-contiguous.

The base station 105 may perform communications over a set of carriers using carrier aggregation techniques in which the base station 105 may configure multiple cells separately for each carrier of the set of carriers, and the base station 105 may configure a UE 115 with carrier aggregation capabilities. However, carrier aggregation may use a high signaling overhead and complex cell management. As such, to reduce the amount of signaling overhead and to reduce the complexity of cell management, the base station 105 may use the flexible cell to transmit system information to a UE 115. For example, using the flexible cell, the base station 105 may transmit an SSB (e.g., minimum system information) on the anchor carrier of the flexible cell, and the base station 105 may transmit other system information (e.g., on-demand system information) and perform related procedures in either the anchor carrier or one of the multiple non-anchor carriers. As such, the flexible cell may introduce more flexibility into the wireless communications system 100 by enabling the base station 105 to perform communications (e.g., random access procedures) using carriers configured for a particular cell for those particular communications.

In some examples, a base station 105 may transmit minimum system information (e.g., a master information block (MIB), a SIB) to a UE 115. For example, the base station 105 may periodically broadcast an MIB to the UE 115 over a broadcast channel, or the base station 105 may unicast or periodically broadcast a SIB1 to one or multiple UEs 115 over a downlink shared channel. Additionally or alternatively, the base station 105 may transmit other system information (e.g., system information other than an MIB or a SIB) to the UE 115.

In some cases, UEs 115 in an idle state (e.g., RRC_IDLE) or an inactive state (e.g., RRC_INACTIVE) may trigger a random access procedure by transmitting a request for other system information to the base station 105 (e.g., a Msg1, a physical random access channel (PRACH) preamble). In some examples, after receiving minimum system information including scheduling information (e.g., a SIB1), a UE 115 may determine a broadcast status of a system information message (e.g., via an si-BroadcastStatus information element). The broadcast status may be included in SIB1. In some examples, the broadcast status may indicate if the base station 105 is broadcasting one or several SIBs within the system information message. For example, if the broadcast status (e.g., in si-BroadcastStatus) is set to “broadcasting,” the UE 115 may acquire the corresponding one or more SIBs (e.g., without using a random access procedure) via one or more broadcast transmissions. If the broadcast status is set to “notbroadcasting,” however, the UE 115 may request system information (e.g., one or more SIBs) in order to receive such system information in an on-demand basis, and so-obtained system information may be referred to as on-demand system information. For example, the UE 115 may initiate a random access procedure to acquire the corresponding one or more SIBs. In some examples, if the base station 105 configures the UE 115 with PRACH resources for a request for system information, then the UE 115 may use a contention-free random access (CFRA) procedure. Otherwise, the UE 115 may use a contention-based random access (CBRA) procedure.

In some examples, a UE 115 may select a normal uplink (NUL) carrier, an SUL carrier, or both for uplink transmissions in an on-demand system information (e.g., CFRA) procedure. In some cases, an SUL carrier may be configured in addition to an NUL carrier for enhanced uplink coverage, reliability, and throughput. A base station 105 may provide SUL carrier information in a SIB1. Additionally or alternatively, for a UE 115 performing a random access procedure for on-demand system information, the base station 105 may configure the SUL carrier for transmission of a PRACH (e.g., Msg1). In some cases, the base station 105 may select whether the NUL carrier or the SUL carrier may be used for the PRACH transmission. The base station 105 may explicitly indicate in the SIB1 whether the UE 115 is to use the NUL carrier or the SUL carrier.

If the base station 105 fails to provide an explicit indication, then the UE 115 may use the SUL carrier if a reference signal received power (RSRP) of a downlink reference signal is less than a threshold for downlink pathloss (e.g., rsrp-ThresholdSSB-SUL information element configured in the SIB1). If the RSRP is greater than the threshold, then the UE 115 may use the NUL carrier. For example, the SUL (e.g., a non-anchor carrier) may have a lower frequency than the NUL carrier, and therefore the SUL carrier may be more reliable than the NUL carrier. As such, if the RSRP is lower than the threshold for the SUL carrier, then the NUL carrier may have a lower RSRP due to its higher frequency compared to that of the SUL carrier. That is, when the RSRP for the SUL carrier is low, generally indicating poor channel conditions for the SUL carrier and the NUL carrier, then the UE 115 may use the SUL carrier because it may be more robust than the NUL carrier (e.g., due to the lower frequency of the SUL carrier).

A base station 105 may support a flexible cell configured with a set of carriers including N non-anchor carriers (e.g., where Nis larger than 1) and an anchor carrier. The set of carriers may be configured for FDD operations, TDD operations, SUL operations, or any combination thereof. In some cases, the base station 105 may configure a UE 115 to perform an on-demand system information procedure over one or multiple carriers of the set of carriers. Because the set of carriers may be available for communications on the flexible cell, the UE 115 may be unaware of which carrier to use (e.g., to monitor) for transmission of a request for the system information and reception of an acknowledgement for the request.

The techniques described herein may enable a UE 115 to select one or more carriers from the set of carriers on the flexible cell for uplink transmission and downlink reception in an on-demand system information procedure. In some examples, the UE 115 may select a carrier for transmission of an uplink random access message (e.g., an uplink PRACH in Msg1) to request on-demand system information and one or more carriers for reception of one or more responsive downlink messages. For example, the UE 115 may select a carrier for the receiving a control message with downlink control information (DCI) (e.g., a physical downlink control channel (PDCCH)). The downlink control message may schedule a shared channel message (e.g., a physical downlink shared channel (PDSCH) carrying Msg2) with the acknowledgement for the request for system information in the shared channel message. Additionally or alternatively, the downlink control message may schedule a shared channel message (e.g., PDSCH) carrying the requested system information. Techniques are further described herein by which the UE 115 may select one or more carriers for receiving such shared channel messages.

In some examples, the UE 115 may select a carrier for transmitting the request based on a carrier identifier, a reference signal measurement, or any combination thereof. Additionally or alternatively, the UE 115 may select a carrier from the set of carriers for reception of the acknowledgement for the request for system information from the base station 105, where the carrier may be the same or different than the carrier selected for the transmission of the request. In some examples, the UE 115 may receive the acknowledgement for the request from the base station 105 via the selected carrier. Additionally or alternatively, the UE 115 may receive the requested system information via a selected carrier after receiving the acknowledgement for the request. For example, the UE 115 may receive the acknowledgement for the request, which may include MAC signaling indicating a carrier for reception of the requested system information. If the base station 105 fails to explicitly indicate a carrier for the reception of the requested system information, the UE 115 may receive the requested system information via the same carrier on which the UE 115 received the acknowledgement, a SIB, or an SSB.

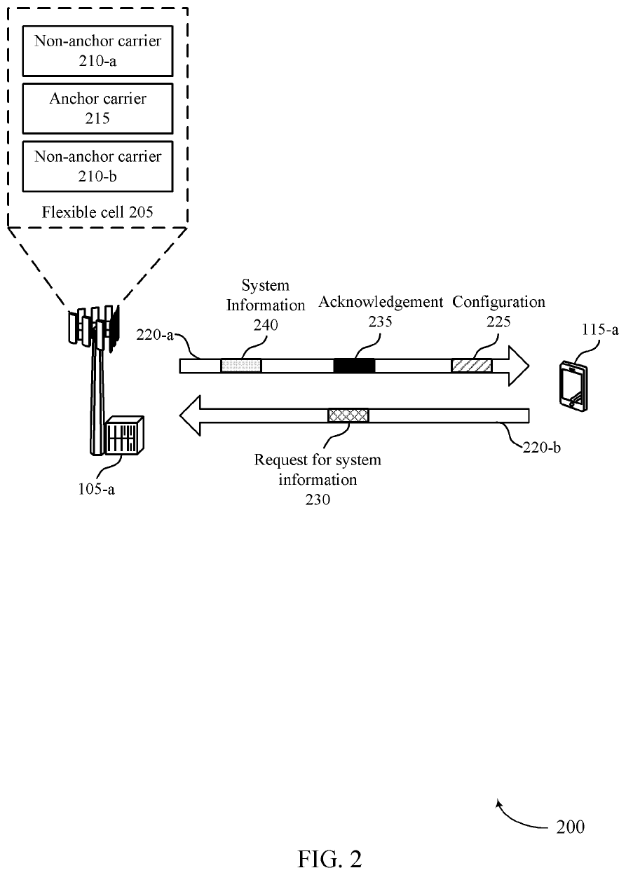

FIG. 2 illustrates an example of a wireless communications system 200 that supports on-demand system information for flexible cells in accordance with aspects of the present disclosure. In some examples, the wireless communications system 200 may implement aspects of the wireless communications system 100 or may be implemented by aspects of the wireless communications system 100. For example, the wireless communications system 200 may include UEs 115 and a base station 105-a, which may be examples of corresponding devices described herein. The wireless communications system 200 may include features for improved communications between the UEs 115 and the base station 105-a.

The base station 105-a may support a flexible cell 205, which may include a set of carriers. The set of carriers may include an anchor carrier 215 and two of more non-anchor carriers 210, the set of carriers supporting FDD operations, TDD operations, SUL operations, or any combination thereof. For example, the flexible cell 205 may include a non-anchor carrier 210-a (e.g., an FDD carrier), the anchor carrier 215 (e.g., a TDD carrier), and a non-anchor carrier 210-b (e.g., an SUL carrier). In some examples, the flexible cell 205 may include any number of non-anchor carriers 210 and anchor carriers 215 supporting different operations.

The base station 105-a and the UE 115-a may communicate via communications links 220. For example, the UE 115-a may receive downlink communications from the base station 105-a via a communications link 220-a and the UE 115-a may transmit uplink communications to the base station 105-a via a communications link 220-b. In some cases, the UE 115-a may receive an indication of a configuration 225 for the flexible cell 205. Based on the indication of the configuration 225, the UE 115-a may select, from among the set of carriers of the flexible cell 205 (e.g., the non-anchor carriers 210 and the anchor carrier 215), a carrier for transmission of a request 230 for system information associated with the flexible cell 205, a carrier for reception of an acknowledgement 235 for the request 230, a carrier for reception of the requested system information 240, or any combination thereof.

For example, the UE 115-a may select a carrier to transmit the request as part of an on-demand system information procedure. That is, the UE 115-a may select a carrier for transmission of an uplink random access message, such as a PRACH (e.g., Msg1), to request on-demand system information.

In some examples, the base station 105-a may (e.g., as part of the configuration 225) explicitly indicate the carrier that the UE 115-a may select for the transmission of the request 230 (e.g., the PRACH transmission, the Msg1). Each carrier in the flexible cell 205 may be associated with a carrier identifier, which the base station 105-a may indicate via the indication of the configuration 225, which may be transmitted as part of system information, via RRC signaling, or both. Thus, in some examples, the UE 115-a may receive an indication of a set of carrier identifiers including a respective carrier identifier for each carrier in the set of carriers. Additionally or alternatively, the base station 105-a may explicitly indicate (e.g., as part of the configuration 225, which may be included in system information or RRC signaling) a carrier identifier corresponding to the carrier the UE 115-a is to use to transmit the request 230. For example, the UE 115-a may receive an indication of the respective carrier identifier corresponding to the carrier that the UE 115-a is to select for the transmission of the request 230.

In some cases, the base station 105-a may refrain from explicitly indicating a carrier selection to the UE 115-a. For example, the UE 115-a may select a carrier to transmit the request 230 (e.g., the PRACH message, the Msg1) based on a measurement (e.g., an RSRP measurement) of a reference signal. The reference signal may be a downlink pathloss reference signal (e.g., an SSB) transmitted on the anchor carrier 215 of the flexible cell 205. For example, the UE 115-a may receive a reference signal from the base station 105-a. The UE 115-a may measure an RSRP for the reference signal, and may select a carrier of the flexible cell 205 for transmission of the request 230 based on the measured RSRP. In some examples, the UE 115-a may select a carrier for uplink transmissions in a random access procedure by comparing a measured RSRP of the reference signal with one or multiple RSRP thresholds. Whether to select the carrier to transmit the request 230 based on a measurement of a reference signal, one or more thresholds for use in selecting the carrier to transmit the request 230 based on a measurement of a reference signal, a mapping between the one or more thresholds and different carriers (or groups of carriers) of the flexible cell, or any combination thereof may be indicated as part of the configuration 225.

In some cases, the base station 105-a may configure one RSRP threshold for both SUL carrier selection and for selection of carrier for transmitting the request 230. For example, the UE 115-a may reuse an RSRP threshold configured for SUL carrier selection (e.g., rsrp-ThresholdSSB-SUL). That is, the UE 115-a may use a single threshold to select one of the two or more non-anchor carriers 210 to use as an SUL carrier. Alternatively, the base station 105-a may configure the UE 115-a with an RSRP threshold to use for the selection of the carrier to transmit the request 230 that is different from the RSRP threshold configured for SUL carrier selection. In some examples, the base station 105-a may configure multiple RSRP thresholds and indicate a mapping between the multiple RSRP thresholds and the set of carriers in the flexible cell 205, for example, via RRC signaling. In some cases, the set of carriers may include one or more subsets of one or more carriers, where each subset corresponds to an RSRP threshold range each delimited by at least one RSRP threshold of the multiple RSRP thresholds. That is, each subset of carriers in the flexible cell 205 may correspond to a range of RSRP thresholds. In some examples, the mapping between the RSRP thresholds and the set of carriers may indicate, to the UE 115-a, which carriers may be in each subset of carriers.

As an example, the base station 105-a may configure two RSRP threshold values, T1 and T2, where T1 may be less than T2. The UE 115-a may compare the measured RSRP for the reference signal to one or both RSRP thresholds by determining that the RSRP for the reference signal is within an RSRP threshold range of the multiple RSRP threshold ranges. The UE 115-a may select the carrier for transmission of the request 230 based on selecting the carrier from a first subset of carriers corresponding to the RSRP threshold range. For example, of the RSRP of the reference signal is less than T1 (e.g., within a first RSRP threshold range including the lowest RSRP threshold value up to the RSRP threshold value T1), then the UE 115-a may select a carrier from a first subset (e.g., subset 1) of carriers (e.g., {f1, f2, . . . , fk}). If the RSRP of the reference signal is greater than or equal to T1 and less than T2 (e.g., within a second RSRP threshold range including RSRP threshold values T1 to T2), the UE 115-a may select a carrier from a second subset (e.g., subset 2) of carriers (e.g., {f{k+1}, f{k+2}, . . . , f{2k}}, where fk<f(k+1)). If the RSRP of the reference signal is greater than or equal to T2 (e.g., within a third RSRP threshold range including the RSRP threshold value T2 to the highest RSRP threshold value), then the UE 115-a may select a carrier from a third subset (e.g., subset 3) of carriers (e.g., {f{2k+1}, f{2k+2}, . . . , f{N+1}}. In some examples, one of the multiple RSRP thresholds may be the RSRP threshold configured for SUL carrier selection.

If the size of the subset of carriers is one (e.g., if there is one carrier in a subset of carriers corresponding to an RSRP threshold range), then the UE 115-a may select the one carrier in the subset for the transmission of the request 230 if the measured RSRP is within the corresponding RSRP threshold range. If the size of the subset of carriers corresponding to the RSRP threshold range is greater than 1 (e.g., if there are multiple carriers in the subset of carriers corresponding to the RSRP threshold range), then the UE 115-a may select the carrier in the subset of carriers with the smallest carrier identifier. In some examples, the smallest carrier identifier may correspond to the carrier with the lowest carrier frequency in the subset. That is, the selected carrier may be lower in frequency than each other carrier in the same subset of carriers.

Once the UE 115-a has selected a carrier from the flexible cell 205, the UE 115-a may transmit the request 230 via the selected carrier. In some cases (e.g., in addition to selecting the carrier for the transmission of the request 230), the UE 115-a may select a carrier from the flexible cell 205 for reception of an acknowledgement 235 for the request 230 associated with the flexible cell. The base station 105-a may transmit the acknowledgement 235 via a Msg2 (e.g., PDCCH, PDSCH, or both).

In some examples, prior to selecting the carrier for reception of the acknowledgement 235, the UE 115-a may receive additional system information (e.g., minimum system information, such as a MIB or SIB1) that may indicate the configuration 225 for the flexible cell. The additional system information may include an indication of a carrier identifier corresponding to the selected carrier. For example, the base station 105-a may explicitly indicate the carrier the UE 115-a is to select to receive the acknowledgement 235 (e.g., the Msg2 PDCCH, PDSCH) via the additional information. In some cases, if the base station 105-a refrains from explicitly indicating the carrier selection, the UE 115-a may select the anchor carrier 215 to receive the acknowledgement 235 (e.g., the anchor carrier 215 may be a default carrier for receiving the acknowledgement 235). That is, an absence from the additional system information of an indication of a carrier identifier for the selected carrier may indicate that the UE 115-a is to select the anchor carrier 215 as the selected carrier, which may be the carrier over which the UE 115-a receives the additional system information minimum system information (e.g., a MIB or SIB1), an SSB, or both. In some cases, the UE 115-a may receive the same indication for a carrier selection for both a control message (e.g., a PDCCH) and a shared channel message (e.g., a PDSCH). That is, the UE 115-a may receive the control message and the shared channel message in the same carrier as indicated by the base station 105-a (e.g., as indicted via a single indication).

In some cases, decoupling the carrier indication for the control channel and the shared channel (e.g., indicating a carrier selection separately for the control channel and the shared channel) may increase flexibility and enhance the capacity of the control channel. For example, for the reception of the acknowledgement 235 (e.g., Msg2), the UE 115-a may use to a first carrier to receive an associated control message (e.g., PDCCH) including DCI scheduling and a second carrier to receive a shared channel message (e.g., PDSCH carrying Msg2), where the shared channel message may be scheduled by the DCI and may include the acknowledgement 235. For example, the UE 115-a may receive the control message via a selected carrier, where the DCI in the control message may schedule the shared channel message and indicate a carrier for reception of the shared channel message. The UE 115-a may receive the shared channel message via the carrier indicated by the corresponding DCI, where the shared channel message may include the acknowledgement 235, and where the carrier indicated by the corresponding DCI may be the same or different than the selected carrier via with the control message (and hence the DCI) is received.

In some examples, the UE 115-a may receive two separate carrier indications in system information (e.g., as part of the configuration 225) from the base station 105-a (e.g., corresponding to the control message and the shared channel message). For example, the UE 115-a may receive a first indication of a first carrier of the set of carriers for the flexible cell 205, the first carrier for receiving a control message. The UE 115-a may receive a second indication of a second carrier of the set of carriers, where the second carrier is the selected carrier and may be for receiving a shared channel message that is scheduled by the control message and that includes the acknowledgement 235. In some examples, the UE 115-a may receive an indication for the control message in system information (e.g., as part of the configuration 225) from the base station 105-a, and the UE 115-a may receive another indication for the shared channel message in the control message, where the shared channel message may carry the acknowledgement 235 (e.g., the Msg 2). For example, prior to selecting the carrier, the UE 115-a may receive additional system information (e.g., minimum system information, such as a MIB or a SIB1) including the first indication of the first carrier and the second indication of the second carrier. Additionally or alternatively, prior to selecting the carrier, the UE 115-a may receive additional system information (e.g., minimum system information) that includes the first indication of the first carrier and the UE 115-a may receive the second indication of the second carrier within the control message. Such additional system information may be the indication of the configuration 225. The first and second carriers may be the same carrier (e.g., both the anchor carrier 215) or different carriers (e.g., the non-anchor carrier 210-a and the anchor carrier 215).

In some cases, the UE 115-a may use PRACH preambles to request on-demand system information (e.g., an on-demand SIB). For example, the UE 115-a may receive (e.g., as part of the configuration 225) an indication of a set of random access (e.g., PRACH) preambles for the UE 115-a to use for transmitting the request 230. Each random access preamble of the set may correspond to a respective set of system information associated with the flexible cell (e.g., as indicated as part of the configuration 225), and hence which random access preamble is transmitted as part of the request 230 may indicate which set of on-demand system information 240 is requested. The UE 115-a may transmit a random access preamble via the selected carrier, where the random access preamble may be one of the set of random access preambles each corresponding to a respective set of system information associated with the flexible cell, and where the request 230 may include a request for the respective set of system information corresponding to the transmitted random access preamble.

In response to the request 230 that includes or is otherwise based on the random access preamble, the base station 105-a may transmit a random access response (RAR), which may be or include the acknowledgement 235 as described herein. The RAR message may be a MAC RAR and may be included in a MAC subPDU, where the carrier that the UE 115-a is to use (e.g., select) to receive the requested system information 240 may be indicated by the MAC RAR. The MAC subPDU may be included in a MAC control element (MAC-CE), for example, or in any other type of MAC message. Thus, for example, the UE 115-a may transmit the request 230 based on (e.g., as including) the random access preamble, and the acknowledgement 235 may include MAC signaling that indicates a carrier via which the UE 115-a is to receive the requested system information 240. The carrier via which the request is transmitted and the carrier via which the acknowledgement is received may be separately selected as described elsewhere herein.

In some cases, the base station 105-a may refrain from explicitly indicating a selected carrier for the UE 115-a to receive the system information 240 (e.g., the requested system information). For example, to receive the system information 240, the UE 115-a may select the same carrier in which the UE 115-a received the control message, the shared channel message, or both carrying the acknowledgement 235 for receiving the system information 240. As another example, in some cases, to receive the system information 240, the UE 115-a may select the same carrier in which the UE 115-a may receive a SIB1 for receiving the system information 240. For example, prior to transmitting the request 230, the UE 115-a may receive a first SIB (e.g., SIB1) via a second carrier of the set of carriers, and after receiving the acknowledgement 235, the UE 115-a may receive the system information 240 via the second carrier. And as yet another example, in some cases, to receive the system information 240, the UE 115-a may select the same carrier in which the UE 115-a may receive an SSB for receiving the system information 240. For example, prior to transmitting the request 230, the UE 115-a may receive an SSB via the second carrier, and after receiving the acknowledgement 235, the UE 115-a may receive the system information 240 via the second carrier. In some cases, information indicated in the configuration 225 may indicate to the UE 115-a which other signaling correspond to the carrier the UE 115-a is to use to receive the system information 240 (e.g., whether the UE 115-a is to receive the system information 240 in the same carrier as one or more messages associated with the acknowledgement 235, in the same carrier as a first SIB, or in the same carrier as an SSB).

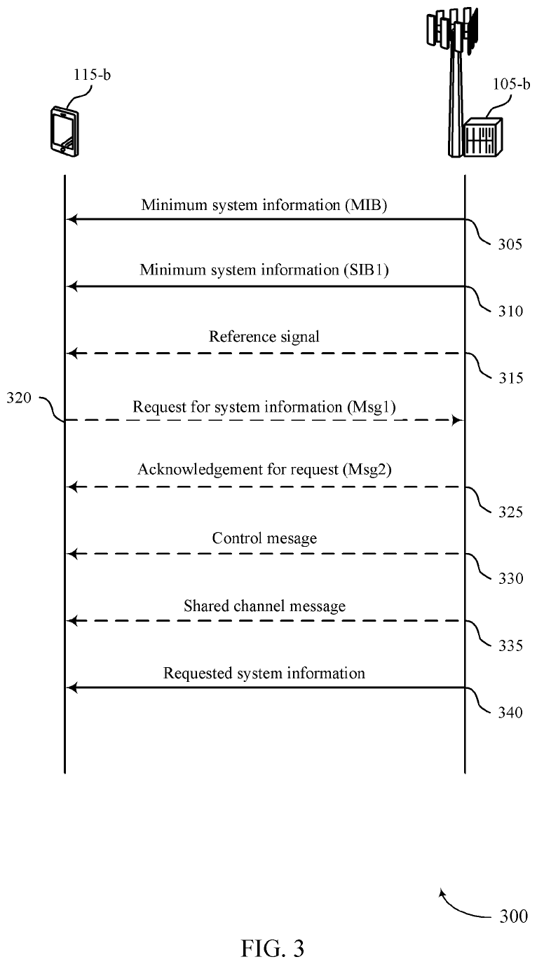

FIG. 3 illustrates an example of a process flow 300 that supports on-demand system information for flexible cells in accordance with aspects of the present disclosure. The process flow 300 may implement aspects of wireless communications systems 100 and 200, or may be implemented by aspects of the wireless communications system 100 and 200. For example, the process flow 300 may illustrate operations between a UE 115-b and a base station 105-b, which may be examples of corresponding devices described herein. In the following description of the process flow 300, the operations between the UE 115-b and the base station 105-b may be transmitted in a different order than the example order shown, or the operations performed by the UE 115-b and the base station 105-b may be performed in different orders or at different times. Some operations may also be omitted from the process flow 300, and other operations may be added to the process flow 300.

As described with reference to FIG. 2, the UE 115-b may select one or more carriers of a flexible cell for uplink transmissions and downlink reception in an on-demand system information procedure. In some cases, the on-demand system information procedure may include the UE 115-b requesting system information from the base station 105-b using a CFRA procedure. In some examples, the system information may be minimum system information (e.g., an MIB, a SIB) or other system information (e.g., a SIB2).

At 305, the UE 115-b may receive minimum system information (e.g., an MIB) from the base station 105-b. In some examples, the base station 105-b may periodically broadcast an MIB over a broadcast channel.

At 310, the UE 115-b may receive minimum system information (e.g., a SIB1) from the base station 105-b. In some cases, the base station 105-b may periodically broadcast a SIB1 on a downlink shared channel, or the base station 105-b may periodically transmit (e.g., unicast) the SIB1 to a particular UE 115. In some examples, the base station 105-b may configure the UE 115-b with dedicated random access resources for a request for system information in the SIB1 (e.g., in SI-RequestConfig within an SI-SchedulingInfo information element in the SIB1).

At 315, the UE 115-b may receive a reference signal from the base station 105-b, such as a downlink pathloss reference signal (e.g., an SSB) transmitted over an anchor carrier. As described with reference to FIG. 2, the UE 115-b may measure a received power level (e.g., an RSRP) for the reference signal, and the UE 115-b may select the carrier for the transmission of the request for the system information based on the received power level. In some examples, the UE 115-b may compare the measured received power level of the reference signal to one or more thresholds, where receiving the indication of the configuration for the flexible cell may include receiving an indication of the one or more thresholds. In addition, the UE 115-b may select the carrier based on the comparison. The one or more thresholds may be indicated by the base station 105-b (e.g., an indication of a configuration for the flexible cell may indicate the or more thresholds).

At 320, the UE 115-b may transmit the request for the system information to the base station 105-b via the selected carrier. For example, the UE 115-b may transmit the request to the base station 105-b (e.g., in a Msg1). In some cases, the UE 115-b may use a Msg1 to indicate a request for other system information, for example by using a particular resource to transmit the Msg1 associated with particular other system information (e.g., SIB2, SIB3) the UE 115-b may be requesting. In some cases, the resources may be indicated in information elements such as ra-PreambleStartIndex, ra-AssociationPeriodIndex, ra-ssb-OccasionMaskIndex, or any combination thereof.

At 325, the UE 115-b may receive an acknowledgement for the request for the system information from the base station 105-b and via the selected carrier, indicating that the base station 105-b received the request. The base station 105-b may transmit the acknowledgement in a Msg2 (e.g., a MAC RAR). For example, after receiving the request for the system information from the UE 115-b in the Msg1, and based on the random access resources the UE 115-b used to transmit the Msg1, the base station 105-b may have information regarding which system information message the UE 115-b is requesting. For example, a resource the UE 115-b used to transmit the Msg1 may implicitly indicate which particular other system information (e.g., which SIB of the set of SIB2 through SIB9) the UE 115-b may be requesting. As such, based on the resource, the base station 105-b may acknowledge the request for the system information in the Msg2. In some examples, after receiving the acknowledgement for the request for the system information (e.g., Msg2), the UE 115-b may receive control messages via a PDCCH (e.g., the UE 115-b may receive a system information-radio network temporary identifier (SI-RNTI)).

Additionally or alternatively, the UE 115-b may receive the acknowledgement for the request for the system information based on a control message and a shared channel message. For example, at 330, the UE 115-b may receive a control message from the base station 105-b via the selected carrier, where DCI in the control message may schedule the shared channel message and indicate a carrier for reception of the shared channel message. In some examples, the UE 115-b may receive a first indication of a first carrier for receiving a control message and a second indication of a second carrier for receiving the shared channel message scheduled by the control message. Additionally or alternatively, the UE 115-b may receive additional system information that may indicate the first carrier for receiving the control message.

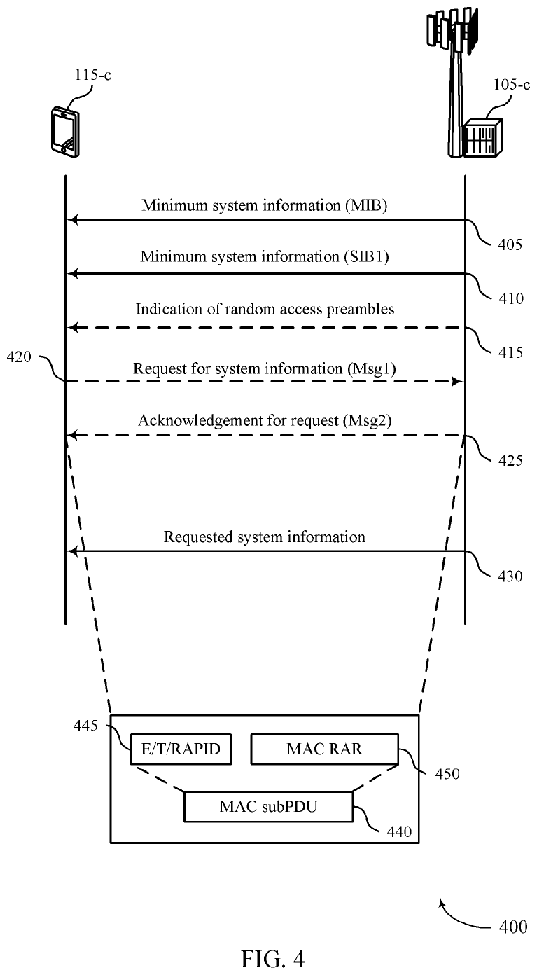

At 335, the UE 115-b may receive, from the base station 105-b, a shared channel message (e.g., scheduled in the control message) via the carrier indicated by the corresponding DCI. In some examples, the shared channel message may include the acknowledgement for request for the system information. As described with reference to FIG. 4, the UE 115-b may select the carrier for reception of the acknowledgement using other methods.

At 340, the UE 115-b may receive the requested system information from the base station 105-b. That is, the base station 105-b may transmit one or more system information messages to the UE 115-b based on the random access resources the UE 115-b used to transmit the Msg1. In some examples, the base station 105-b may transmit other system information (e.g., system information other than an MIB or a SIB1, such as SIB2 through SIB9) in various ways. For example, the base station 105-b may periodically broadcast the other system information on a downlink shared channel, the base station 105-b may broadcast on-demand system information on a downlink shared channel, for example upon receiving a request from a UEs 115 in an idle state (e.g., RRC_IDLE) or an inactive state (e.g., RRC_INACTIVE), or the base station 105-b may transmit the other system information in a dedicated manner over a downlink shared channel to UEs 115 in a connected state (e.g., RRC_CONNECTED).

FIG. 4 illustrates an example of a process flow 400 that supports on-demand system information for flexible cells in accordance with aspects of the present disclosure. The process flow 400 may implement aspects of wireless communications systems 100 and 200, or may be implemented by aspects of the wireless communications system 100 and 200. For example, the process flow 400 may illustrate operations between a UE 115-c and a base station 105-c, which may be examples of corresponding devices described herein. In the following description of the process flow 400, the operations between the UE 115-c and the base station 105-c may be transmitted in a different order than the example order shown, or the operations performed by the UE 115-c and the base station 105-c may be performed in different orders or at different times. Some operations may also be omitted from the process flow 400, and other operations may be added to the process flow 400. Further, aspects of the process flow 400 may be combined with aspects of the process flow 300 in any combination.

As described with reference to FIGS. 2 and 3, the UE 115-c may select one or more carriers of a flexible cell for uplink transmissions and downlink reception in an on-demand system information procedure. In some cases, the UE 115-c may request system information from the base station 105-c using a CFRA procedure. In some examples, the system information may be minimum system information (e.g., an MIB, a SIB) or other system information (e.g., a SIB2).

At 405, the UE 115-c may receive minimum system information (e.g., an MIB) from the base station 105-c. In some examples, the base station 105-c may periodically broadcast an MIB over a broadcast channel.

At 410, the UE 115-c may receive minimum system information (e.g., SIB1) from the base station 105-c. In some cases, the base station 105-c may periodically broadcast a SIB1 on a downlink shared channel, or the base station 105-c may periodically transmit the SIB1 to a particular UE 115 (e.g., unicast). In some examples, the base station 105-c may configure the UE 115-c with dedicated random access resources for a request for system information in the SIB1 (e.g., in SI-RequestConfig within an SI-SchedulingInfo information element in the SIB1). In some cases, the UE 115-c may receive the SIB1 via a carrier of a set of carriers for the flexible cell, where the same carrier may be used to receive system information.

In some examples, the UE 115-c may use PRACH preambles configured for on-demand system information in the flexible cell. For example, at 415, the UE 115-c may receive an indication of a set of random access preambles (e.g., PRACH preambles) for the UE to use for transmitting the request for the system information. Each random access preamble of the set may correspond to a respective set of system information associated with the flexible cell, and hence which random access preamble is transmitted (at 420) as part of the request 230 may indicate which set of on-demand system information 240 is requested.

At 420, the UE 115-c may transmit the request for the system information to the base station 105-c via a selected carrier. As described with reference to FIGS. 2 and 3, the UE 115-c may select the carrier based on an indication from the base station 105-c, a measured RSRP of a downlink pathloss reference signal, or another method. Additionally or alternatively, the request for the system information may be a PRACH preamble, where different PRACH preambles of a set of PRACH preambles may correspond to different sets of on-demand system information. For example, the UE 115-c may transmit the request for the system information based on a random access preamble of the set of random access preambles indicated at 415.

At 425, the UE 115-c may receive an acknowledgement (e.g., an acknowledgement 235) for the request for the system information from the base station 105-c and via the selected carrier, indicating that the base station 105-c received the request. The base station 105-c may transmit the acknowledgement in a Msg2 (e.g., the MAC RAR 450). In some examples, the acknowledgment may be or include MAC signaling. For example, at 425, the UE 115-c may receive the MAC signaling indicating a second carrier of the set of carriers for the flexible cell, where the UE 115-c may receive the requested system information via the second carrier. In some cases, the acknowledgement for the request for the system information (e.g., Msg2) may be carried in a MAC subPDU 440 that is received at 425, and MAC subPDU 440 may include the acknowledgement along with a MAC RAR 450, where the MAC RAR 450 may include an indication of the carrier that the UE 115-c is to select as the selected carrier for subsequent reception of the requested system information.

Thus, a MAC RAR 450 may be included in a MAC subPDU 440 received at 425, and the selected carrier via which the requested system information is to be subsequently received may be indicated by the MAC RAR 450. In some cases, the MAC subPDU 440 may also include a MAC subheader 445, and the MAC subheader 445 may include a random access preamble identifier (RAPID), where the RAPID may identify the random access preamble used by the UE 115-c at 420 to transmit the Msg1 at 420. In some cases, in addition to the RAPID, the MAC subheader 445 may include an Extension (E) field indicating whether the MAC subPDU 440 is the last MAC subPDU in a corresponding MAC PDU, along with a Type (T) field indicating whether the MAC subheader 445 includes a RAPID.

At 430, the UE 115-c may receive the requested system information from the base station 105-c. That is, the base station 105-c may transmit one or more system information messages to the UE 115-c corresponding to the random access resources (e.g., the random access preamble) that the UE 115-c used to transmit the Msg1 at 420. For example, the base station 105-c may transmit the requested system information via the second carrier, where the second carrier may have been indicated in the MAC RAR 450.

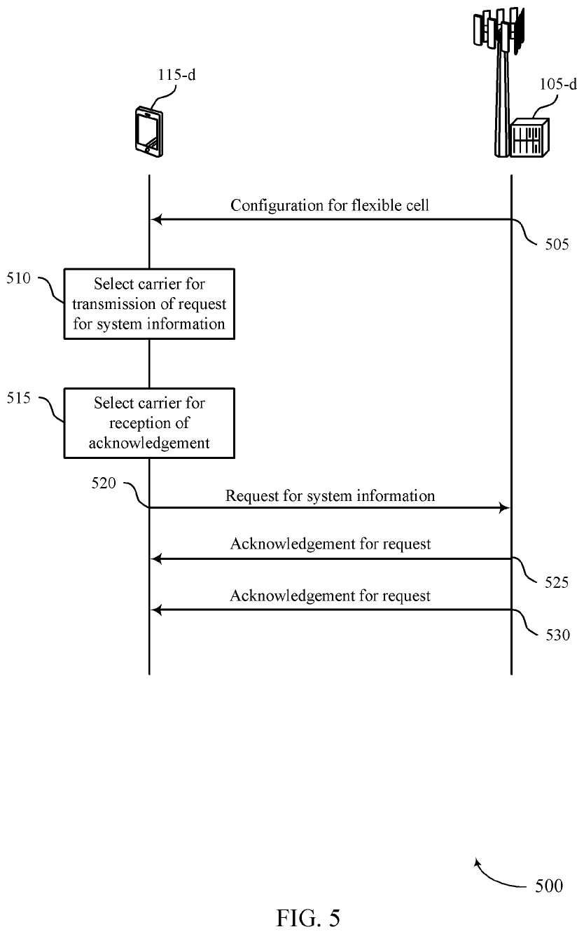

FIG. 5 illustrates an example of a process flow 500 that supports on-demand system information for flexible cells in accordance with aspects of the present disclosure. The process flow 500 may implement aspects of wireless communications systems 100 and 200, or may be implemented by aspects of the wireless communications system 100 and 200. For example, the process flow 500 may illustrate operations between a UE 115-d and a base station 105-d, which may be examples of corresponding devices described herein. In the following description of the process flow 500, the operations between the UE 115-d and the base station 105-d may be transmitted in a different order than the example order shown, or the operations performed by the UE 115-d and the base station 105-d may be performed in different orders or at different times. Some operations may also be omitted from the process flow 500, and other operations may be added to the process flow 500.

At 505, the UE 115-d may receive, from the base station 105-d an indication of a configuration for a flexible cell supported by the base station 105-d. The flexile cell may include a set of carriers including an anchor carrier and two or more non-anchor carriers, which may support any combination of FDD operations, TDD operations, and SUL operations.

At 510, the UE 115-d may select, from among the set of carriers of the flexible cell and based on the configuration for the flexible cell, a first carrier for transmission of a request for system information associated with the flexible cell. In some examples, the UE 115-d may select the first carrier based on an indication from the base station 105-d, a carrier identifier associated each carrier of the set of carriers, a measured received power level of a downlink pathloss reference signal, or any combination thereof.

At 515, the UE 115-d may select, from among the set of carries of the flexible cell and based on the configuration for the flexible cell, a second carrier for reception by the UE 115-d of an acknowledgement for the request for the system information associated with the flexible cell. For example, the UE 115-d may select the second carrier based on a control message, a shared channel message, a PRACH preamble, or any combination thereof.

At 520, the UE 115-d may transmit the request for the system information via the selected first carrier. In some examples, the UE 115-d may transmit a random access preamble corresponding to a respective set of system information, where the request for the system information includes a request for the respective set of system information corresponding to the transmitted random access preamble.

At 525, the UE 115-d may receive the acknowledgement for the request for the system information via the selected second carrier. In some examples, the UE 115-d may receive the acknowledgement in a RAR (e.g., a MAC RAR) in response to transmitting the random access preamble.

At 530, after receiving the acknowledgement for the request, the UE 115-d may receive, from the base station 105-d, the requested system information associated with the flexible cell via a carrier selected for the reception of the system information. The selected carrier may be the same carrier on which the UE 115-d received the acknowledgement, a SIB (e.g., a SIB1), or an SSB.

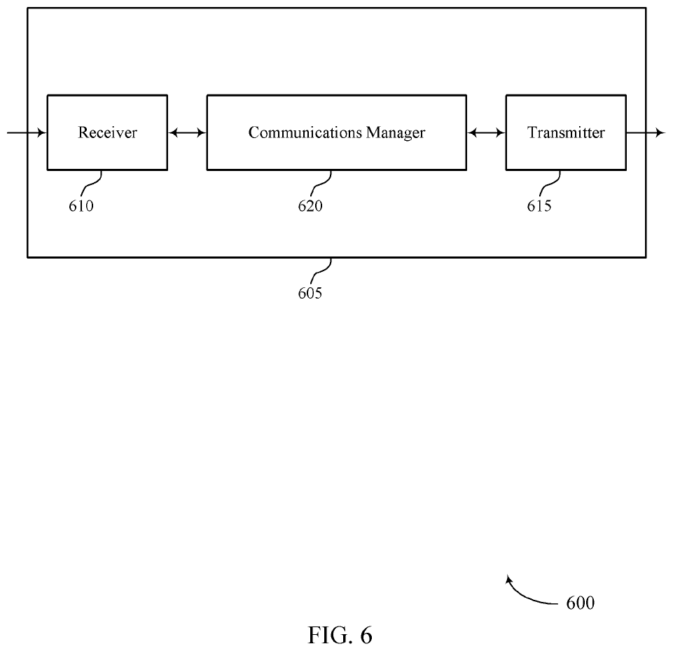

FIG. 6 shows a block diagram 600 of a device 605 that supports on-demand system information for flexible cells in accordance with aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to on-demand system information for flexible cells). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to on-demand system information for flexible cells). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of on-demand system information for flexible cells as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may be configured to receive or transmit messages or other signaling as described herein via the transceiver module. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a UE in accordance with examples as disclosed herein. For example, the communications manager 620 may be configured as or otherwise support a means for receiving an indication of a configuration for a flexible cell supported by a base station, where the flexible cell includes a set of carriers including an anchor carrier and two or more non-anchor carriers. The communications manager 620 may be configured as or otherwise support a means for selecting, from among the set of carriers of the flexible cell and based on the configuration for the flexible cell, a carrier for transmission of a request for system information associated with the flexible cell. The communications manager 620 may be configured as or otherwise support a means for transmitting the request for the system information via the selected carrier.

Additionally or alternatively, the communications manager 620 may support wireless communication at a UE in accordance with examples as disclosed herein. For example, the communications manager 620 may be configured as or otherwise support a means for receiving an indication of a configuration for a flexible cell supported by a base station, where the flexible cell includes a set of carriers including an anchor carrier and two or more non-anchor carriers. The communications manager 620 may be configured as or otherwise support a means for selecting, from among the set of carriers of the flexible cell and based on the configuration for the flexible cell, a carrier for reception by the UE of an acknowledgement for a request for system information associated with the flexible cell. The communications manager 620 may be configured as or otherwise support a means for transmitting, to the base station, the request for the system information associated with the flexible cell. The communications manager 620 may be configured as or otherwise support a means for receiving the acknowledgement for the request for the system information via the selected carrier.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for communicating on-demand system information in a flexible cell, which may increase the efficiency and reduce latency of the communications by enabling the UE to select and be aware of a carrier for the system information communications.

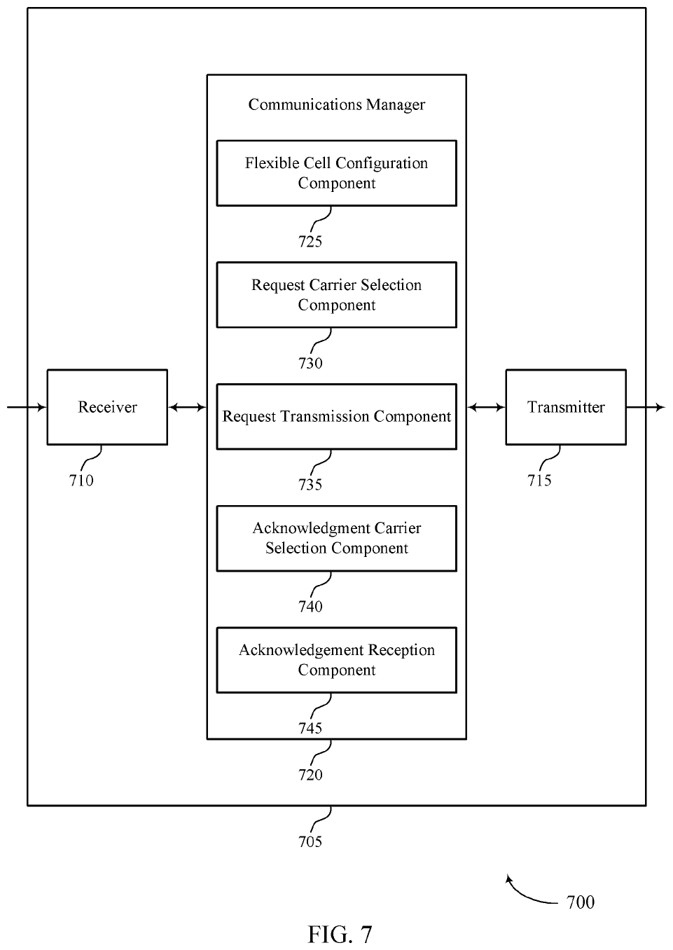

FIG. 7 shows a block diagram 700 of a device 705 that supports on-demand system information for flexible cells in accordance with aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to on-demand system information for flexible cells). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to on-demand system information for flexible cells). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of on-demand system information for flexible cells as described herein. For example, the communications manager 720 may include a flexible cell configuration component 725, a request carrier selection component 730, a request transmission component 735, an acknowledgment carrier selection component 740, an acknowledgement reception component 745, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication at a UE in accordance with examples as disclosed herein. The flexible cell configuration component 725 may be configured as or otherwise support a means for receiving an indication of a configuration for a flexible cell supported by a base station, where the flexible cell includes a set of carriers including an anchor carrier and two or more non-anchor carriers. The request carrier selection component 730 may be configured as or otherwise support a means for selecting, from among the set of carriers of the flexible cell and based on the configuration for the flexible cell, a carrier for transmission of a request for system information associated with the flexible cell. The request transmission component 735 may be configured as or otherwise support a means for transmitting the request for the system information via the selected carrier.

Additionally or alternatively, the communications manager 720 may support wireless communication at a UE in accordance with examples as disclosed herein. The flexible cell configuration component 725 may be configured as or otherwise support a means for receiving an indication of a configuration for a flexible cell supported by a base station, where the flexible cell includes a set of carriers including an anchor carrier and two or more non-anchor carriers. The acknowledgment carrier selection component 740 may be configured as or otherwise support a means for selecting, from among the set of carriers of the flexible cell and based on the configuration for the flexible cell, a carrier for reception by the UE of an acknowledgement for a request for system information associated with the flexible cell. The request transmission component 735 may be configured as or otherwise support a means for transmitting, to the base station, the request for the system information associated with the flexible cell. The acknowledgement reception component 745 may be configured as or otherwise support a means for receiving the acknowledgement for the request for the system information via the selected carrier.

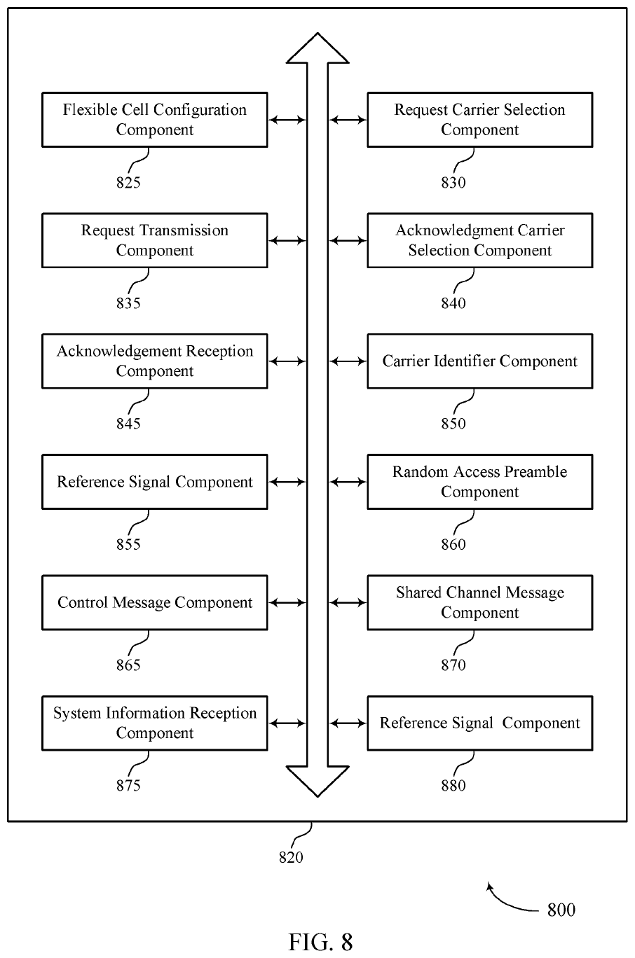

FIG. 8 shows a block diagram 800 of a communications manager 820 that supports on-demand system information for flexible cells in accordance with aspects of the present disclosure. The communications manager 820 may be an example of aspects of a communications manager 620, a communications manager 720, or both, as described herein. The communications manager 820, or various components thereof, may be an example of means for performing various aspects of on-demand system information for flexible cells as described herein. For example, the communications manager 820 may include a flexible cell configuration component 825, a request carrier selection component 830, a request transmission component 835, an acknowledgment carrier selection component 840, an acknowledgement reception component 845, a carrier identifier component 850, a reference signal component 855, a random access preamble component 860, a control message component 865, a shared channel message component 870, a system information reception component 875, a reference signal component 880, or any combination thereof. Each of these components may communicate, directly or indirectly, with one another (e.g., via one or more buses).

The communications manager 820 may support wireless communication at a UE in accordance with examples as disclosed herein. The flexible cell configuration component 825 may be configured as or otherwise support a means for receiving an indication of a configuration for a flexible cell supported by a base station, where the flexible cell includes a set of carriers including an anchor carrier and two or more non-anchor carriers. The request carrier selection component 830 may be configured as or otherwise support a means for selecting, from among the set of carriers of the flexible cell and based on the configuration for the flexible cell, a carrier for transmission of a request for system information associated with the flexible cell. The request transmission component 835 may be configured as or otherwise support a means for transmitting the request for the system information via the selected carrier.

In some examples, to support receiving the indication of the configuration for the flexible cell, the carrier identifier component 850 may be configured as or otherwise support a means for receiving an indication of a set of carrier identifiers including a respective carrier identifier for each carrier of the set of carriers. In some examples, to support receiving the indication of the configuration for the flexible cell, the carrier identifier component 850 may be configured as or otherwise support a means for receiving an indication of the respective carrier identifier for the selected carrier, where the indication of the respective carrier identifier for the selected carrier indicates which carrier the UE is to select for transmission of the request for the system information.

In some examples, to support receiving the indication of the configuration for the flexible cell, the carrier identifier component 850 may be configured as or otherwise support a means for receiving RRC signaling that indicates the set of carrier identifiers, the respective carrier identifier for the selected carrier, or both.

In some examples, to support receiving the indication of the set of carrier identifiers, the carrier identifier component 850 may be configured as or otherwise support a means for receiving system information that indicates the set of carrier identifiers, the respective carrier identifier for the selected carrier, or both.

In some examples, the reference signal component 855 may be configured as or otherwise support a means for receiving a reference signal from the base station. In some examples, the reference signal component 855 may be configured as or otherwise support a means for measuring a received power level for the reference signal, where selecting the carrier based on the configuration for the flexible cell includes selecting the carrier for transmission of the request for the system information based on the received power level for the reference signal.

In some examples, the reference signal component 880 may be configured as or otherwise support a means for comparing the received power level for the reference signal to one or more thresholds, where receiving the indication of the configuration for the flexible cell includes receiving an indication of the one or more thresholds, and where selecting the carrier for transmission of the request for the system information is based on the comparing. The flexible cell configuration component 825 may be configured as or otherwise support a means for receiving an indication of the one or more thresholds (e.g., an indication of a configuration for the flexible cell may indicate the one or more thresholds).

In some examples, the one or more thresholds includes a single threshold, and the reference signal component 855 may be configured as or otherwise support a means for using the single threshold to select one of the two or more non-anchor carriers to use as an SUL carrier.

In some examples, the set of carriers includes a set of multiple subsets of one or more carriers, the set of multiple subsets corresponding to a set of multiple received power ranges that are each delimited by at least one threshold of the one or more thresholds. In some examples, comparing the received power level for the reference signal to the one or more thresholds includes determining that the received power level for the reference signal is within a first received power range of the set of multiple received power ranges. In some examples, selecting the carrier for transmission of the request for the system information includes selecting the carrier from a first subset of carriers based on the first subset of carriers corresponding to the first received power range.

In some examples, to support selecting the carrier from the first subset of carriers, the reference signal component 855 may be configured as or otherwise support a means for selecting a first carrier based on the first carrier being associated with a lowest carrier identifier from among one or more carrier identifiers corresponding to the first subset of carriers. In some examples, the first carrier is lower in frequency than each other carrier in the first subset of carriers.

In some examples, to support transmitting the request for the system information, the random access preamble component 860 may be configured as or otherwise support a means for transmitting a random access preamble via the selected carrier, where the random access preamble is one of a set of random access preambles each corresponding to a respective set of system information associated with the flexible cell, and where the request for system information associated with the flexible cell includes a request for the respective set of system information corresponding to the transmitted random access preamble.

Additionally or alternatively, the communications manager 820 may support wireless communication at a UE in accordance with examples as disclosed herein. In some examples, the flexible cell configuration component 825 may be configured as or otherwise support a means for receiving an indication of a configuration for a flexible cell supported by a base station, where the flexible cell includes a set of carriers including an anchor carrier and two or more non-anchor carriers. The acknowledgment carrier selection component 840 may be configured as or otherwise support a means for selecting, from among the set of carriers of the flexible cell and based on the configuration for the flexible cell, a carrier for reception by the UE of an acknowledgement for a request for system information associated with the flexible cell. In some examples, the request transmission component 835 may be configured as or otherwise support a means for transmitting, to the base station, the request for the system information associated with the flexible cell. The acknowledgement reception component 845 may be configured as or otherwise support a means for receiving the acknowledgement for the request for the system information via the selected carrier.

In some examples, to support receiving the indication of the configuration for the flexible cell, the flexible cell configuration component 825 may be configured as or otherwise support a means for receiving, prior to selecting the carrier, additional system information that indicates the configuration for the flexible cell.

In some examples, the additional system information includes an indication of a carrier identifier for the selected carrier. In some examples, an absence from the additional system information of an indication of a carrier identifier for the selected carrier includes an indication that the UE is to select the anchor carrier as the selected carrier.

In some examples, to support receiving the acknowledgement for the request for the system information via the selected carrier, the control message component 865 may be configured as or otherwise support a means for receiving a control message via the selected carrier. In some examples, to support receiving the acknowledgement for the request for the system information via the selected carrier, the shared channel message component 870 may be configured as or otherwise support a means for receiving a shared channel message via the selected carrier, the shared channel message scheduled by the control message and including the acknowledgement.

In some examples, to support receiving the indication of the configuration for the flexible cell, the control message component 865 may be configured as or otherwise support a means for receiving a first indication of a first carrier of the set of carriers, where the first carrier is for receiving a control message. In some examples, to support receiving the indication of the configuration for the flexible cell, the shared channel message component 870 may be configured as or otherwise support a means for receiving a second indication of a second carrier of the set of carriers, where the second carrier includes the selected carrier and is for receiving a shared channel message that is scheduled by the control message and includes the acknowledgement.

In some examples, to support receiving the indication of the configuration for the flexible cell, the control message component 865 may be configured as or otherwise support a means for receiving, prior to selecting the carrier, additional system information that includes the first indication of the first carrier and the second indication of the second carrier.

In some examples, to support receiving the indication of the configuration for the flexible cell, the control message component 865 may be configured as or otherwise support a means for receiving, prior to selecting the carrier, additional system information that includes the first indication of the first carrier. In some examples, to support receiving the indication of the configuration for the flexible cell, the control message component 865 may be configured as or otherwise support a means for receiving the second indication of the second carrier within the control message. In some examples, the first carrier is different than the second carrier. In some examples, the first carrier and the second carrier include a same carrier.

In some examples, to support receiving the indication of the configuration for the flexible cell, the random access preamble component 860 may be configured as or otherwise support a means for receiving an indication of a set of random access preambles for the UE to use for transmitting system information requests.

In some examples, the random access preamble component 860 may be configured as or otherwise support a means for transmitting the request for the system information associated with the flexible cell using a preamble of the set of random access preambles. In some examples, the random access preamble component 860 may be configured as or otherwise support a means for receiving the system information associated with the flexible cell via a second carrier of the set of carriers, where the acknowledgement for the request includes MAC signaling that indicates the second carrier.

In some examples, the system information reception component 875 may be configured as or otherwise support a means for receiving, after receiving the acknowledgement for the request via the selected carrier, the system information associated with the flexible cell via the selected carrier.

In some examples, the system information reception component 875 may be configured as or otherwise support a means for receiving, prior to transmitting the request for the system information associated with the flexible cell, a first SIB via a second carrier of the set of carriers. In some examples, the system information reception component 875 may be configured as or otherwise support a means for receiving, after receiving the acknowledgement for the request via the selected carrier, the system information associated with the flexible cell via the second carrier.

In some examples, the system information reception component 875 may be configured as or otherwise support a means for receiving, prior to transmitting the request for the system information associated with the flexible cell, an SSB via a second carrier of the set of carriers. In some examples, the system information reception component 875 may be configured as or otherwise support a means for receiving, after receiving the acknowledgement for the request via the selected carrier, the system information associated with the flexible cell via the second carrier.

In some examples, transmitting the request for the system information includes transmitting a random access preamble. In some examples, receiving the acknowledgement for the request for the system information includes receiving a RAR message in response to transmitting the random access preamble.

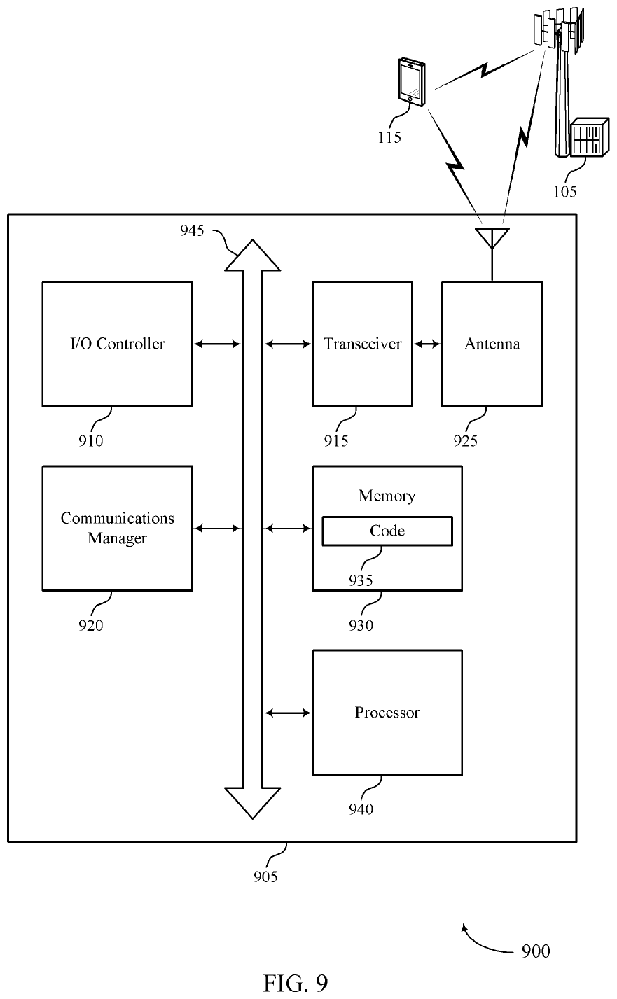

FIG. 9 shows a diagram of a system 900 including a device 905 that supports on-demand system information for flexible cells in accordance with aspects of the present disclosure. The device 905 may be an example of or include the components of a device 605, a device 705, or a UE 115 as described herein. The device 905 may communicate wirelessly with one or more base stations 105, UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting on-demand system information for flexible cells). For example, the device 905 or a component of the device 905 may include a processor 940 and memory 930 coupled with the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for receiving an indication of a configuration for a flexible cell supported by a base station, where the flexible cell includes a set of carriers including an anchor carrier and two or more non-anchor carriers. The communications manager 920 may be configured as or otherwise support a means for selecting, from among the set of carriers of the flexible cell and based on the configuration for the flexible cell, a carrier for transmission of a request for system information associated with the flexible cell. The communications manager 920 may be configured as or otherwise support a means for transmitting the request for the system information via the selected carrier.

Additionally or alternatively, the communications manager 920 may support wireless communication at a UE in accordance with examples as disclosed herein. For example, the communications manager 920 may be configured as or otherwise support a means for receiving an indication of a configuration for a flexible cell supported by a base station, where the flexible cell includes a set of carriers including an anchor carrier and two or more non-anchor carriers. The communications manager 920 may be configured as or otherwise support a means for selecting, from among the set of carriers of the flexible cell and based on the configuration for the flexible cell, a carrier for reception by the UE of an acknowledgement for a request for system information associated with the flexible cell. The communications manager 920 may be configured as or otherwise support a means for transmitting, to the base station, the request for the system information associated with the flexible cell. The communications manager 920 may be configured as or otherwise support a means for receiving the acknowledgement for the request for the system information via the selected carrier.

By including or configuring the communications manager 920 in accordance with examples as described herein, the device 905 may support techniques for communicating on-demand system information in a flexible cell, which may increase the efficiency and reduce latency of the communications by enabling the UE to select and be aware of a carrier for the system information communications.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of on-demand system information for flexible cells as described herein, or the processor 940 and the memory 930 may be otherwise configured to perform or support such operations.

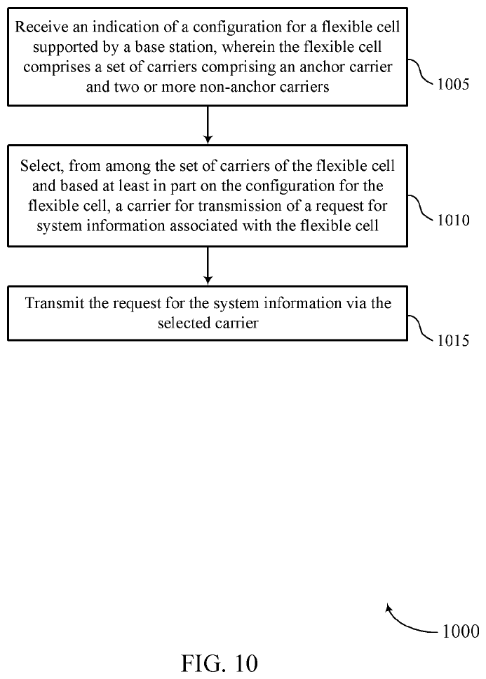

FIG. 10 shows a flowchart illustrating a method 1000 that supports on-demand system information for flexible cells in accordance with aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1005, the method may include receiving an indication of a configuration for a flexible cell supported by a base station, where the flexible cell includes a set of carriers including an anchor carrier and two or more non-anchor carriers. The operations of 1005 may be performed in accordance with examples as disclosed herein. In some examples, aspects of the operations of 1005 may be performed by a flexible cell configuration component 825 as described with reference to FIG. 8. Additionally or alternatively, means for performing 1005 may, but not necessarily, include, for example, an antenna 925, a transceiver 915, a communications manager 920, a memory 930 (including code 935), a processor 940, a bus 945, or any combination thereof.

At 1010, the method may include selecting, from among the set of carriers of the flexible cell and based on the configuration for the flexible cell, a carrier for transmission of a request for system information associated with the flexible cell. The operations of 1010 may be performed in accordance with examples as disclosed herein. In some examples, aspects of the operations of 1010 may be performed by a request carrier selection component 830 as described with reference to FIG. 8. Additionally or alternatively, means for performing 1010 may, but not necessarily, include, for example, the antenna 925, the transceiver 915, the communications manager 920, the memory 930 (including code 935), the processor 940, the bus 945, or any combination thereof.

At 1015, the method may include transmitting the request for the system information via the selected carrier. The operations of 1015 may be performed in accordance with examples as disclosed herein. In some examples, aspects of the operations of 1015 may be performed by a request transmission component 835 as described with reference to FIG. 8. Additionally or alternatively, means for performing 1015 may, but not necessarily, include, for example, the antenna 925, the transceiver 915, the communications manager 920, the memory 930 (including code 935), the processor 940, the bus 945, or any combination thereof.

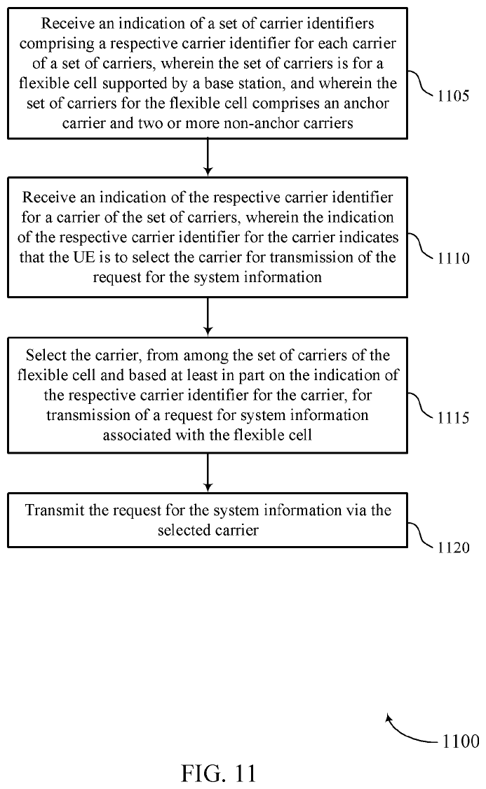

FIG. 11 shows a flowchart illustrating a method 1100 that supports on-demand system information for flexible cells in accordance with aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1105, the method may include receiving an indication of a set of carrier identifiers comprising a respective carrier identifier for each carrier of a set of carriers, wherein the set of carriers is for a flexible cell supported by a base station, and wherein the set of carriers for the flexible cell comprises an anchor carrier and two or more non-anchor carriers. The operations of 1105 may be performed in accordance with examples as disclosed herein. In some examples, aspects of the operations of 1105 may be performed by a carrier identifier component 850 as described with reference to FIG. 8. Additionally or alternatively, means for performing 1105 may, but not necessarily, include, for example, an antenna 925, a transceiver 915, a communications manager 920, a memory 930 (including code 935), a processor 940, a bus 945, or any combination thereof.

At 1110, the method may include receiving an indication of the respective carrier identifier for a carrier of the set of carriers, wherein the indication of the respective carrier identifier for the carrier indicates that the UE is to select the carrier for transmission of the request for the system information. The operations of 1110 may be performed in accordance with examples as disclosed herein. In some examples, aspects of the operations of 1110 may be performed by a carrier identifier component 850 as described with reference to FIG. 8. Additionally or alternatively, means for performing 1110 may, but not necessarily, include, for example, the antenna 925, the transceiver 915, the communications manager 920, the memory 930 (including code 935), the processor 940, the bus 945, or any combination thereof.

At 1115, the method may include selecting the carrier, from among the set of carriers of the flexible cell and based on the indication of the respective carrier identifier for the carrier, for transmission of a request for system information associated with the flexible cell. The operations of 1115 may be performed in accordance with examples as disclosed herein. In some examples, aspects of the operations of 1115 may be performed by a request carrier selection component 830 as described with reference to FIG. 8. Additionally or alternatively, means for performing 1115 may, but not necessarily, include, for example, the antenna 925, the transceiver 915, the communications manager 920, the memory 930 (including code 935), the processor 940, the bus 945, or any combination thereof.

At 1120, the method may include transmitting the request for the system information via the selected carrier. The operations of 1120 may be performed in accordance with examples as disclosed herein. In some examples, aspects of the operations of 1120 may be performed by a request transmission component 835 as described with reference to FIG. 8. Additionally or alternatively, means for performing 1120 may, but not necessarily, include, for example, the antenna 925, the transceiver 915, the communications manager 920, the memory 930 (including code 935), the processor 940, the bus 945, or any combination thereof.

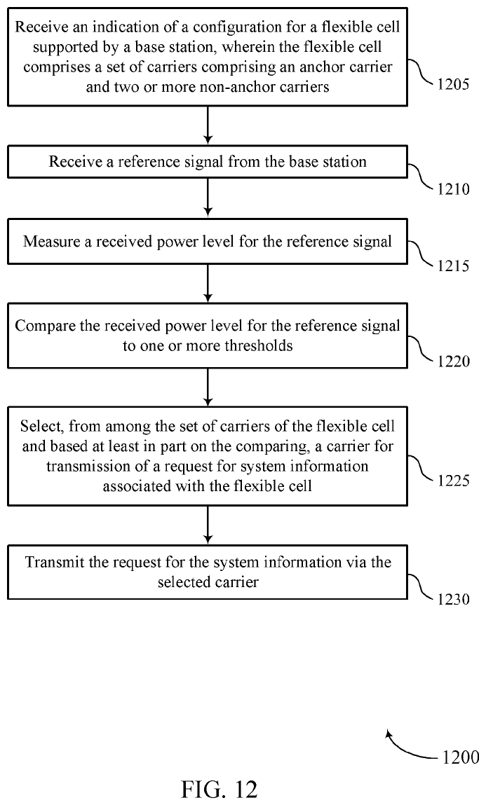

FIG. 12 shows a flowchart illustrating a method 1200 that supports on-demand system information for flexible cells in accordance with aspects of the present disclosure. The operations of the method 1200 may be implemented by a UE or its components as described herein. For example, the operations of the method 1200 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1205, the method may include receiving an indication of a configuration for a flexible cell supported by a base station, where the flexible cell includes a set of carriers including an anchor carrier and two or more non-anchor carriers. The operations of 1205 may be performed in accordance with examples as disclosed herein. In some examples, aspects of the operations of 1205 may be performed by a flexible cell configuration component 825 as described with reference to FIG. 8. Additionally or alternatively, means for performing 1205 may, but not necessarily, include, for example, an antenna 925, a transceiver 915, a communications manager 920, a memory 930 (including code 935), a processor 940, a bus 945, or any combination thereof.

At 1210, the method may include receiving a reference signal from the base station. The operations of 1210 may be performed in accordance with examples as disclosed herein. In some examples, aspects of the operations of 1210 may be performed by a reference signal component 855 as described with reference to FIG. 8. Additionally or alternatively, means for performing 1210 may, but not necessarily, include, for example, the antenna 925, the transceiver 915, the communications manager 920, the memory 930 (including code 935), the processor 940, the bus 945, or any combination thereof.

At 1215, the method may include measuring a received power level for the reference signal. The operations of 1215 may be performed in accordance with examples as disclosed herein. In some examples, aspects of the operations of 1215 may be performed by a reference signal component 855 as described with reference to FIG. 8. Additionally or alternatively, means for performing 1215 may, but not necessarily, include, for example, the antenna 925, the transceiver 915, the communications manager 920, the memory 930 (including code 935), the processor 940, the bus 945, or any combination thereof.

At 1220, the method may include comparing the received power level for the reference signal to one or more thresholds. In some cases, receiving the indication of the configuration for the flexible cell may include receiving an indication of the one or more thresholds. The operations of 1220 may be performed in accordance with examples as disclosed herein. In some examples, aspects of the operations of 1220 may be performed by a reference signal component 880 as described with reference to FIG. 8. Additionally or alternatively, means for performing 1220 may, but not necessarily, include, for example, the antenna 925, the transceiver 915, the communications manager 920, the memory 930 (including code 935), the processor 940, the bus 945, or any combination thereof.

At 1225, the method may include selecting, from among the set of carriers of the flexible cell and based on the comparing, a carrier for transmission of a request for system information associated with the flexible cell. The operations of 1225 may be performed in accordance with examples as disclosed herein. In some examples, aspects of the operations of 1225 may be performed by a request carrier selection component 830 as described with reference to FIG. 8. Additionally or alternatively, means for performing 1225 may, but not necessarily, include, for example, the antenna 925, the transceiver 915, the communications manager 920, the memory 930 (including code 935), the processor 940, the bus 945, or any combination thereof.

At 1230, the method may include transmitting the request for the system information via the selected carrier. The operations of 1230 may be performed in accordance with examples as disclosed herein. In some examples, aspects of the operations of 1230 may be performed by a request transmission component 835 as described with reference to FIG. 8. Additionally or alternatively, means for performing 1230 may, but not necessarily, include, for example, the antenna 925, the transceiver 915, the communications manager 920, the memory 930 (including code 935), the processor 940, the bus 945, or any combination thereof.

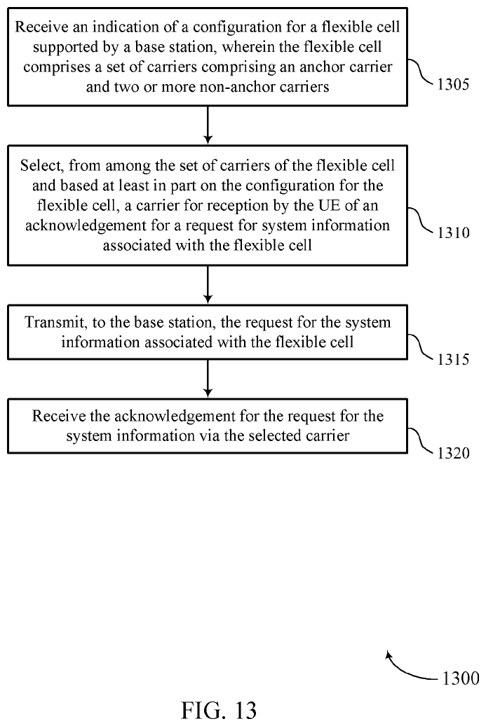

FIG. 13 shows a flowchart illustrating a method 1300 that supports on-demand system information for flexible cells in accordance with aspects of the present disclosure. The operations of the method 1300 may be implemented by a UE or its components as described herein. For example, the operations of the method 1300 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1305, the method may include receiving an indication of a configuration for a flexible cell supported by a base station, where the flexible cell includes a set of carriers including an anchor carrier and two or more non-anchor carriers. The operations of 1305 may be performed in accordance with examples as disclosed herein. In some examples, aspects of the operations of 1305 may be performed by a flexible cell configuration component 825 as described with reference to FIG. 8. Additionally or alternatively, means for performing 1305 may, but not necessarily, include, for example, an antenna 925, a transceiver 915, a communications manager 920, a memory 930 (including code 935), a processor 940, a bus 945, or any combination thereof.

At 1310, the method may include selecting, from among the set of carriers of the flexible cell and based on the configuration for the flexible cell, a carrier for reception by the UE of an acknowledgement for a request for system information associated with the flexible cell. The operations of 1310 may be performed in accordance with examples as disclosed herein. In some examples, aspects of the operations of 1310 may be performed by an acknowledgment carrier selection component 840 as described with reference to FIG. 8. Additionally or alternatively, means for performing 1310 may, but not necessarily, include, for example, the antenna 925, the transceiver 915, the communications manager 920, the memory 930 (including code 935), the processor 940, the bus 945, or any combination thereof.

At 1315, the method may include transmitting, to the base station, the request for the system information associated with the flexible cell. The operations of 1315 may be performed in accordance with examples as disclosed herein. In some examples, aspects of the operations of 1315 may be performed by a request transmission component 835 as described with reference to FIG. 8. Additionally or alternatively, means for performing 1315 may, but not necessarily, include, for example, the antenna 925, the transceiver 915, the communications manager 920, the memory 930 (including code 935), the processor 940, the bus 945, or any combination thereof.

At 1320, the method may include receiving the acknowledgement for the request for the system information via the selected carrier. The operations of 1320 may be performed in accordance with examples as disclosed herein. In some examples, aspects of the operations of 1320 may be performed by an acknowledgement reception component 845 as described with reference to FIG. 8. Additionally or alternatively, means for performing 1320 may, but not necessarily, include, for example, the antenna 925, the transceiver 915, the communications manager 920, the memory 930 (including code 935), the processor 940, the bus 945, or any combination thereof.

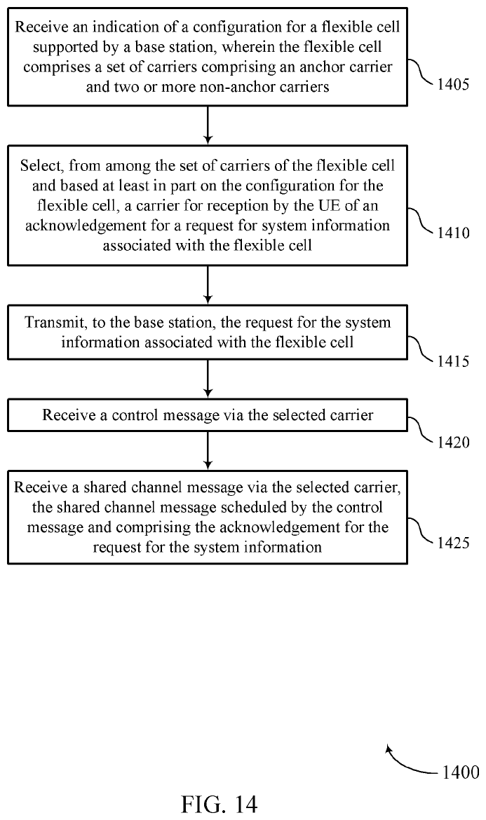

FIG. 14 shows a flowchart illustrating a method 1400 that supports on-demand system information for flexible cells in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1405, the method may include receiving an indication of a configuration for a flexible cell supported by a base station, where the flexible cell includes a set of carriers including an anchor carrier and two or more non-anchor carriers. The operations of 1405 may be performed in accordance with examples as disclosed herein. In some examples, aspects of the operations of 1405 may be performed by a flexible cell configuration component 825 as described with reference to FIG. 8. Additionally or alternatively, means for performing 1405 may, but not necessarily, include, for example, an antenna 925, a transceiver 915, a communications manager 920, a memory 930 (including code 935), a processor 940, a bus 945, or any combination thereof.

At 1410, the method may include selecting, from among the set of carriers of the flexible cell and based on the configuration for the flexible cell, a carrier for reception by the UE of an acknowledgement for a request for system information associated with the flexible cell. The operations of 1410 may be performed in accordance with examples as disclosed herein. In some examples, aspects of the operations of 1410 may be performed by an acknowledgment carrier selection component 840 as described with reference to FIG. 8. Additionally or alternatively, means for performing 1410 may, but not necessarily, include, for example, the antenna 925, the transceiver 915, the communications manager 920, the memory 930 (including code 935), the processor 940, the bus 945, or any combination thereof.

At 1415, the method may include transmitting, to the base station, the request for the system information associated with the flexible cell. The operations of 1415 may be performed in accordance with examples as disclosed herein. In some examples, aspects of the operations of 1415 may be performed by a request transmission component 835 as described with reference to FIG. 8. Additionally or alternatively, means for performing 1415 may, but not necessarily, include, for example, the antenna 925, the transceiver 915, the communications manager 920, the memory 930 (including code 935), the processor 940, the bus 945, or any combination thereof.

At 1420, the method may include receiving a control message via the selected carrier. The operations of 1420 may be performed in accordance with examples as disclosed herein. In some examples, aspects of the operations of 1420 may be performed by a control message component 865 as described with reference to FIG. 8. Additionally or alternatively, means for performing 1420 may, but not necessarily, include, for example, the antenna 925, the transceiver 915, the communications manager 920, the memory 930 (including code 935), the processor 940, the bus 945, or any combination thereof.

At 1425, the method may include receiving a shared channel message via the selected carrier, the shared channel message scheduled by the control message and including the acknowledgement for the request for the system information. The operations of 1425 may be performed in accordance with examples as disclosed herein. In some examples, aspects of the operations of 1425 may be performed by a shared channel message component 870 as described with reference to FIG. 8. Additionally or alternatively, means for performing 1425 may, but not necessarily, include, for example, the antenna 925, the transceiver 915, the communications manager 920, the memory 930 (including code 935), the processor 940, the bus 945, or any combination thereof.

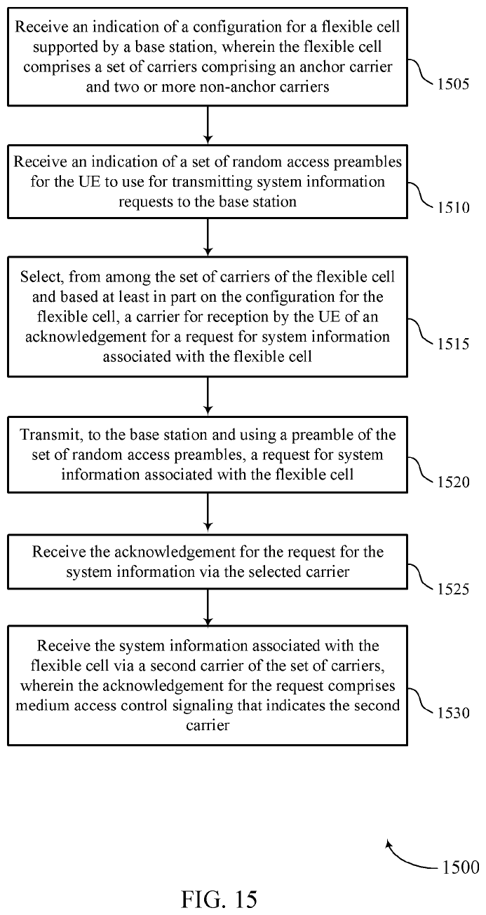

FIG. 15 shows a flowchart illustrating a method 1500 that supports on-demand system information for flexible cells in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1505, the method may include receiving an indication of a configuration for a flexible cell supported by a base station, where the flexible cell includes a set of carriers including an anchor carrier and two or more non-anchor carriers. The operations of 1505 may be performed in accordance with examples as disclosed herein. In some examples, aspects of the operations of 1505 may be performed by a flexible cell configuration component 825 as described with reference to FIG. 8. Additionally or alternatively, means for performing 1505 may, but not necessarily, include, for example, an antenna 925, a transceiver 915, a communications manager 920, a memory 930 (including code 935), a processor 940, a bus 945, or any combination thereof.

At 1510, the method may include receiving an indication of a set of random access preambles for the UE to use for transmitting system information requests to the base station. The operations of 1510 may be performed in accordance with examples as disclosed herein. In some examples, aspects of the operations of 1510 may be performed by a random access preamble component 860 as described with reference to FIG. 8. Additionally or alternatively, means for performing 1510 may, but not necessarily, include, for example, the antenna 925, the transceiver 915, the communications manager 920, the memory 930 (including code 935), the processor 940, the bus 945, or any combination thereof.

At 1515, the method may include selecting, from among the set of carriers of the flexible cell and based on the configuration for the flexible cell, a carrier for reception by the UE of an acknowledgement for a request for system information associated with the flexible cell. The operations of 1515 may be performed in accordance with examples as disclosed herein. In some examples, aspects of the operations of 1515 may be performed by an acknowledgment carrier selection component 840 as described with reference to FIG. 8. Additionally or alternatively, means for performing 1515 may, but not necessarily, include, for example, the antenna 925, the transceiver 915, the communications manager 920, the memory 930 (including code 935), the processor 940, the bus 945, or any combination thereof.

At 1520, the method may include transmitting, to the base station and using a preamble of the set of random access preambles, the request for the system information associated with the flexible cell. The operations of 1520 may be performed in accordance with examples as disclosed herein. In some examples, aspects of the operations of 1520 may be performed by a random access preamble component 860 as described with reference to FIG. 8. Additionally or alternatively, means for performing 1520 may, but not necessarily, include, for example, the antenna 925, the transceiver 915, the communications manager 920, the memory 930 (including code 935), the processor 940, the bus 945, or any combination thereof.

At 1525, the method may include receiving the acknowledgement for the request for the system information via the selected carrier. The operations of 1525 may be performed in accordance with examples as disclosed herein. In some examples, aspects of the operations of 1525 may be performed by an acknowledgement reception component 845 as described with reference to FIG. 8. Additionally or alternatively, means for performing 1525 may, but not necessarily, include, for example, the antenna 925, the transceiver 915, the communications manager 920, the memory 930 (including code 935), the processor 940, the bus 945, or any combination thereof.

At 1530, the method may include receiving the system information associated with the flexible cell via a second carrier of the set of carriers, where the acknowledgement for the request includes MAC signaling that indicates the second carrier. The operations of 1530 may be performed in accordance with examples as disclosed herein. In some examples, aspects of the operations of 1530 may be performed by a random access preamble component 860 as described with reference to FIG. 8. Additionally or alternatively, means for performing 1530 may, but not necessarily, include, for example, the antenna 925, the transceiver 915, the communications manager 920, the memory 930 (including code 935), the processor 940, the bus 945, or any combination thereof.

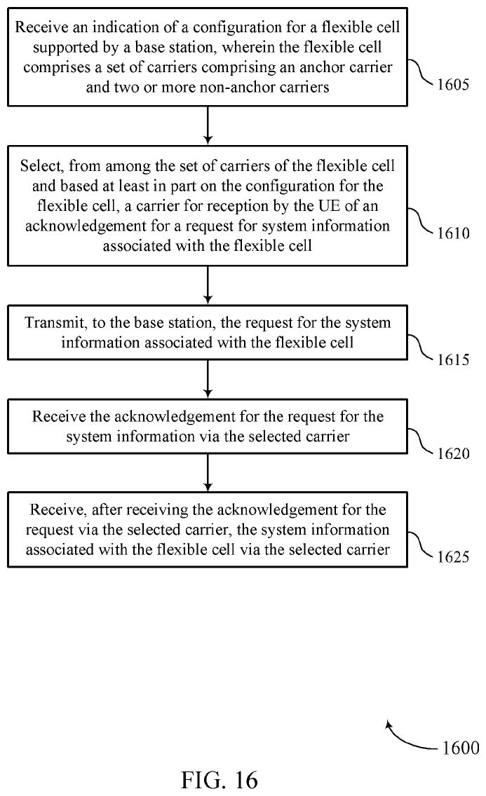

FIG. 16 shows a flowchart illustrating a method 1600 that supports on-demand system information for flexible cells in accordance with aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1605, the method may include receiving an indication of a configuration for a flexible cell supported by a base station, where the flexible cell includes a set of carriers including an anchor carrier and two or more non-anchor carriers. The operations of 1605 may be performed in accordance with examples as disclosed herein. In some examples, aspects of the operations of 1605 may be performed by a flexible cell configuration component 825 as described with reference to FIG. 8. Additionally or alternatively, means for performing 1605 may, but not necessarily, include, for example, an antenna 925, a transceiver 915, a communications manager 920, a memory 930 (including code 935), a processor 940, a bus 945, or any combination thereof.

At 1610, the method may include selecting, from among the set of carriers of the flexible cell and based on the configuration for the flexible cell, a carrier for reception by the UE of an acknowledgement for a request for system information associated with the flexible cell. The operations of 1610 may be performed in accordance with examples as disclosed herein. In some examples, aspects of the operations of 1610 may be performed by an acknowledgment carrier selection component 840 as described with reference to FIG. 8. Additionally or alternatively, means for performing 1610 may, but not necessarily, include, for example, the antenna 925, the transceiver 915, the communications manager 920, the memory 930 (including code 935), the processor 940, the bus 945, or any combination thereof.

At 1615, the method may include transmitting, to the base station, the request for the system information associated with the flexible cell. The operations of 1615 may be performed in accordance with examples as disclosed herein. In some examples, aspects of the operations of 1615 may be performed by a request transmission component 835 as described with reference to FIG. 8. Additionally or alternatively, means for performing 1615 may, but not necessarily, include, for example, the antenna 925, the transceiver 915, the communications manager 920, the memory 930 (including code 935), the processor 940, the bus 945, or any combination thereof.

At 1620, the method may include receiving the acknowledgement for the request for the system information via the selected carrier. The operations of 1620 may be performed in accordance with examples as disclosed herein. In some examples, aspects of the operations of 1620 may be performed by an acknowledgement reception component 845 as described with reference to FIG. 8. Additionally or alternatively, means for performing 1620 may, but not necessarily, include, for example, the antenna 925, the transceiver 915, the communications manager 920, the memory 930 (including code 935), the processor 940, the bus 945, or any combination thereof.

At 1625, the method may include receiving, after receiving the acknowledgement for the request via the selected carrier, the system information associated with the flexible cell via the selected carrier. The operations of 1625 may be performed in accordance with examples as disclosed herein. In some examples, aspects of the operations of 1625 may be performed by a system information reception component 875 as described with reference to FIG. 8. Additionally or alternatively, means for performing 1625 may, but not necessarily, include, for example, the antenna 925, the transceiver 915, the communications manager 920, the memory 930 (including code 935), the processor 940, the bus 945, or any combination thereof.

The following provides an overview of aspects of the present disclosure:

Aspect 1: A method for wireless communication at a UE, comprising: receiving an indication of a configuration for a flexible cell supported by a base station, wherein the flexible cell comprises a set of carriers comprising an anchor carrier and two or more non-anchor carriers; selecting, from among the set of carriers of the flexible cell and based at least in part on the configuration for the flexible cell, a carrier for transmission of a request for system information associated with the flexible cell; and transmitting the request for the system information via the selected carrier.

Aspect 2: The method of aspect 1, wherein receiving the indication of the configuration for the flexible cell comprises: receiving an indication of a set of carrier identifiers comprising a respective carrier identifier for each carrier of the set of carriers; and receiving an indication of the respective carrier identifier for the selected carrier, wherein the indication of the respective carrier identifier for the selected carrier indicates which carrier the UE is to select for transmission of the request for the system information.

Aspect 3: The method of aspect 2, wherein receiving the indication of the configuration for the flexible cell comprises: receiving RRC signaling that indicates the set of carrier identifiers, the respective carrier identifier for the selected carrier, or both.

Aspect 4: The method of any of aspects 2 through 3, wherein receiving the indication of the set of carrier identifiers comprises: receiving system information that indicates the set of carrier identifiers, the respective carrier identifier for the selected carrier, or both.

Aspect 5: The method of any of aspects 1 through 4, further comprising: receiving a reference signal from the base station; and measuring a received power level for the reference signal, wherein selecting the carrier based at least in part on the configuration for the flexible cell comprises selecting the carrier for transmission of the request for the system information based at least in part on the received power level for the reference signal.

Aspect 6: The method of aspect 5, further comprising: comparing the received power level for the reference signal to one or more thresholds, wherein receiving the indication of the configuration for the flexible cell comprises receiving an indication of the one or more thresholds, and wherein selecting the carrier for transmission of the request for the system information is based at least in part on the comparing.

Aspect 7: The method of aspect 6, wherein the one or more thresholds comprises a single threshold, the method further comprising: using the single threshold to select one of the two or more non-anchor carriers to use as an SUL carrier.

Aspect 8: The method of any of aspects 6 through 7, wherein the set of carriers comprises a plurality of subsets of one or more carriers, the plurality of subsets corresponding to a plurality of received power ranges that are each delimited by at least one threshold of the one or more thresholds; comparing the received power level for the reference signal to the one or more thresholds comprises determining that the received power level for the reference signal is within a first received power range of the plurality of received power ranges; and selecting the carrier for transmission of the request for the system information comprises selecting the carrier from a first subset of carriers based at least in part on the first subset of carriers corresponding to the first received power range.

Aspect 9: The method of aspect 8, wherein selecting the carrier from the first subset of carriers comprises: selecting a first carrier based at least in part on the first carrier being associated with a lowest carrier identifier from among one or more carrier identifiers corresponding to the first subset of carriers.

Aspect 10: The method of aspect 9, wherein the first carrier is lower in frequency than each other carrier in the first subset of carriers.

Aspect 11: The method of any of aspects 1 through 10, wherein transmitting the request for the system information comprises: transmitting a random access preamble via the selected carrier, wherein the random access preamble is one of a set of random access preambles each corresponding to a respective set of system information associated with the flexible cell, and wherein the request for system information associated with the flexible cell comprises a request for the respective set of system information corresponding to the transmitted random access preamble.

Aspect 12: A method for wireless communication at a UE, comprising: receiving an indication of a configuration for a flexible cell supported by a base station, wherein the flexible cell comprises a set of carriers comprising an anchor carrier and two or more non-anchor carriers; selecting, from among the set of carriers of the flexible cell and based at least in part on the configuration for the flexible cell, a carrier for reception by the UE of an acknowledgement for a request for system information associated with the flexible cell; transmitting, to the base station, the request for the system information associated with the flexible cell; and receiving the acknowledgement for the request for the system information via the selected carrier.

Aspect 13: The method of aspect 12, wherein receiving the indication of the configuration for the flexible cell comprises: receiving, prior to selecting the carrier, additional system information that indicates the configuration for the flexible cell.

Aspect 14: The method of aspect 13, wherein the additional system information comprises an indication of a carrier identifier for the selected carrier.

Aspect 15: The method of any of aspects 13 through 14, wherein an absence from the additional system information of an indication of a carrier identifier for the selected carrier comprises an indication that the UE is to select the anchor carrier as the selected carrier.

Aspect 16: The method of any of aspects 13 through 15, wherein receiving the acknowledgement for the request for the system information via the selected carrier comprises: receiving a control message via the selected carrier; and receiving a shared channel message via the selected carrier, the shared channel message scheduled by the control message and comprising the acknowledgement.

Aspect 17: The method of any of aspects 12 through 16, wherein receiving the indication of the configuration for the flexible cell comprises receiving a first indication of a first carrier of the set of carriers, wherein the first carrier is for receiving a control message, the method further comprising receiving a second indication of a second carrier of the set of carriers, wherein the second carrier comprises the selected carrier and is for receiving a shared channel message that is scheduled by the control message and comprises the acknowledgement.

Aspect 18: The method of aspect 17, wherein receiving the indication of the configuration for the flexible cell comprises: receiving, prior to selecting the carrier, additional system information that comprises the first indication of the first carrier and the second indication of the second carrier.

Aspect 19: The method of any of aspects 17 through 18, wherein receiving the indication of the configuration for the flexible cell comprises: receiving, prior to selecting the carrier, additional system information that comprises the first indication of the first carrier; and receiving the second indication of the second carrier within the control message.

Aspect 20: The method of any of aspects 17 through 19, wherein the first carrier is different than the second carrier.

Aspect 21: The method of any of aspects 17 through 20, wherein the first carrier and the second carrier comprise a same carrier.

Aspect 22: The method of any of aspects 12 through 21, wherein receiving the indication of the configuration for the flexible cell comprises: receiving an indication of a set of random access preambles for the UE to use for transmitting system information requests.

Aspect 23: The method of aspect 22, wherein the request for the system information associated with the flexible cell is transmitted using a preamble of the set of random access preambles, the method further comprising: receiving the system information associated with the flexible cell via a second carrier of the set of carriers, wherein the acknowledgement for the request comprises MAC signaling that indicates the second carrier.

Aspect 24: The method of any of aspects 12 through 23, further comprising: receiving, after receiving the acknowledgement for the request via the selected carrier, the system information associated with the flexible cell via the selected carrier.

Aspect 25: The method of any of aspects 12 through 24, further comprising: receiving, prior to transmitting the request for the system information associated with the flexible cell, a first SIB via a second carrier of the set of carriers; and receiving, after receiving the acknowledgement for the request via the selected carrier, the system information associated with the flexible cell via the second carrier.

Aspect 26: The method of any of aspects 12 through 25, further comprising: receiving, prior to transmitting the request for the system information associated with the flexible cell, an SSB via a second carrier of the set of carriers; and receiving, after receiving the acknowledgement for the request via the selected carrier, the system information associated with the flexible cell via the second carrier.

Aspect 27: The method of any of aspects 12 through 26, wherein transmitting the request for the system information comprises transmitting a random access preamble; and receiving the acknowledgement for the request for the system information comprises receiving a RAR message in response to transmitting the random access preamble.

Aspect 28: An apparatus for wireless communication at a UE, comprising memory, a transceiver, and at least one processor of a UE, the at least one processor coupled with the memory and the transceiver, and the at least one processor configured to cause the apparatus to perform a method of any of aspects 1 through 11.

Aspect 29: An apparatus for wireless communication at a UE, comprising at least one means for performing a method of any of aspects 1 through 11.

Aspect 30: A non-transitory computer-readable medium storing code for wireless communication at a UE, the code comprising instructions executable by a processor to perform a method of any of aspects 1 through 11.

Aspect 31: An apparatus for wireless communication at a UE, comprising memory, a transceiver, and at least one processor of a UE, the at least one processor coupled with the memory and the transceiver, and the at least one processor configured to cause the apparatus to perform a method of any of aspects 12 through 27.

Aspect 32: An apparatus for wireless communication at a UE, comprising at least one means for performing a method of any of aspects 12 through 27.

Aspect 33: A non-transitory computer-readable medium storing code for wireless communication at a UE, the code comprising instructions executable by a processor to perform a method of any of aspects 12 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database, or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving an indication of a configuration for a flexible cell supported by a base station, wherein the flexible cell comprises a set of carriers comprising an anchor carrier and two or more non-anchor carriers;
selecting, from among the set of carriers of the flexible cell and based at least in part on the configuration for the flexible cell, a carrier for transmission of a request for system information associated with the flexible cell; and
transmitting the request for the system information via the selected carrier.

2. The method of claim 1, wherein receiving the indication of the configuration for the flexible cell comprises:
receiving an indication of a set of carrier identifiers comprising a respective carrier identifier for each carrier of the set of carriers; and
receiving an indication of the respective carrier identifier for the selected carrier, wherein the indication of the respective carrier identifier for the selected carrier indicates which carrier the UE is to select for transmission of the request for the system information.

3. The method of claim 2, wherein receiving the indication of the configuration for the flexible cell comprises:
receiving radio resource control signaling that indicates the set of carrier identifiers, the respective carrier identifier for the selected carrier, or both.

4. The method of claim 2, wherein receiving the indication of the set of carrier identifiers comprises:
receiving system information that indicates the set of carrier identifiers, the respective carrier identifier for the selected carrier, or both.

5. The method of claim 1, further comprising:
receiving a reference signal from the base station; and
measuring a received power level for the reference signal, wherein selecting the carrier based at least in part on the configuration for the flexible cell comprises selecting the carrier for transmission of the request for the system information based at least in part on the received power level for the reference signal.

6. The method of claim 5, further comprising:
comparing the received power level for the reference signal to one or more thresholds, wherein receiving the indication of the configuration for the flexible cell comprises receiving an indication of the one or more thresholds, and wherein selecting the carrier for transmission of the request for the system information is based at least in part on the comparing.

7. The method of claim 6, wherein the one or more thresholds comprises a single threshold, the method further comprising:
using the single threshold to select one of the two or more non-anchor carriers to use as a supplemental uplink carrier.

8. The method of claim 6, wherein:
the set of carriers comprises a plurality of subsets of one or more carriers, the plurality of subsets corresponding to a plurality of received power ranges that are each delimited by at least one threshold of the one or more thresholds;
comparing the received power level for the reference signal to the one or more thresholds comprises determining that the received power level for the reference signal is within a first received power range of the plurality of received power ranges; and
selecting the carrier for transmission of the request for the system information comprises selecting the carrier from a first subset of carriers based at least in part on the first subset of carriers corresponding to the first received power range.

9. The method of claim 8, wherein selecting the carrier from the first subset of carriers comprises:
selecting a first carrier based at least in part on the first carrier being associated with a lowest carrier identifier from among one or more carrier identifiers corresponding to the first subset of carriers.

10. The method of claim 9, wherein the first carrier is lower in frequency than each other carrier in the first subset of carriers.

11. The method of claim 1, wherein transmitting the request for the system information comprises:
transmitting a random access preamble via the selected carrier, wherein the random access preamble is one of a set of random access preambles each corresponding to a respective set of system information associated with the flexible cell, and wherein the request for system information associated with the flexible cell comprises a request for the respective set of system information corresponding to the transmitted random access preamble.

12. A method for wireless communication at a user equipment (UE), comprising:
receiving an indication of a configuration for a flexible cell supported by a base station, wherein the flexible cell comprises a set of carriers comprising an anchor carrier and two or more non-anchor carriers;
selecting, from among the set of carriers of the flexible cell and based at least in part on the configuration for the flexible cell, a carrier for reception by the UE of an acknowledgement for a request for system information associated with the flexible cell;
transmitting, to the base station, the request for the system information associated with the flexible cell; and
receiving the acknowledgement for the request for the system information via the selected carrier.

13. The method of claim 12, wherein receiving the indication of the configuration for the flexible cell comprises:
receiving, prior to selecting the carrier, additional system information that indicates the configuration for the flexible cell.

14. The method of claim 13, wherein the additional system information comprises an indication of a carrier identifier for the selected carrier.

15. The method of claim 13, wherein an absence from the additional system information of an indication of a carrier identifier for the selected carrier comprises an indication that the UE is to select the anchor carrier as the selected carrier.

16. The method of claim 13, wherein receiving the acknowledgement for the request for the system information via the selected carrier comprises:
receiving a control message via the selected carrier; and
receiving a shared channel message via the selected carrier, the shared channel message scheduled by the control message and comprising the acknowledgement.

17. The method of claim 12, wherein receiving the indication of the configuration for the flexible cell comprises receiving a first indication of a first carrier of the set of carriers, wherein the first carrier is for receiving a control message, the method further comprising:
receiving a second indication of a second carrier of the set of carriers, wherein the second carrier comprises the selected carrier and is for receiving a shared channel message that is scheduled by the control message and comprises the acknowledgement.

18. The method of claim 17, wherein receiving the indication of the configuration for the flexible cell comprises:
receiving, prior to selecting the carrier, additional system information that comprises the first indication of the first carrier and the second indication of the second carrier.

19. The method of claim 17, wherein receiving the indication of the configuration for the flexible cell comprises:
receiving, prior to selecting the carrier, additional system information that comprises the first indication of the first carrier; and
receiving the second indication of the second carrier within the control message.

20. The method of claim 17, wherein the first carrier is different than the second carrier.

21. The method of claim 17, wherein the first carrier and the second carrier comprise a same carrier.

22. The method of claim 12, wherein receiving the indication of the configuration for the flexible cell comprises:
receiving an indication of a set of random access preambles for the UE to use for transmitting system information requests.

23. The method of claim 22, wherein the request for the system information associated with the flexible cell is transmitted using a preamble of the set of random access preambles, the method further comprising:
receiving the system information associated with the flexible cell via a second carrier of the set of carriers, wherein the acknowledgement for the request comprises medium access control signaling that indicates the second carrier.

24. The method of claim 12, further comprising:
receiving, after receiving the acknowledgement for the request via the selected carrier, the system information associated with the flexible cell via the selected carrier.

25. The method of claim 12, further comprising:
receiving, prior to transmitting the request for the system information associated with the flexible cell, a first system information block via a second carrier of the set of carriers; and
receiving, after receiving the acknowledgement for the request via the selected carrier, the system information associated with the flexible cell via the second carrier.

26. The method of claim 12, further comprising:
receiving, prior to transmitting the request for the system information associated with the flexible cell, a synchronization signal block via a second carrier of the set of carriers; and
receiving, after receiving the acknowledgement for the request via the selected carrier, the system information associated with the flexible cell via the second carrier.

27. The method of claim 12, wherein:
transmitting the request for the system information comprises transmitting a random access preamble; and
receiving the acknowledgement for the request for the system information comprises receiving a random access response message in response to transmitting the random access preamble.

28. An apparatus for wireless communication, comprising:
memory;
a transceiver; and
at least one processor of a user equipment (UE), the at least one processor coupled with the memory and the transceiver, and the at least one processor configured to cause the apparatus to:
receive, via the transceiver, an indication of a configuration for a flexible cell supported by a base station, wherein the flexible cell comprises a set of carriers comprising an anchor carrier and two or more non-anchor carriers;
select, from among the set of carriers of the flexible cell and based at least in part on the configuration for the flexible cell, a carrier for transmission of a request for system information associated with the flexible cell; and
transmit, via the transceiver, the request for the system information via the selected carrier.

29. The apparatus of claim 28, wherein, to receive the indication of the configuration for the flexible cell, the at least one processor is further configured to cause the apparatus to:
receive, via the transceiver, an indication of a set of carrier identifiers comprising a respective carrier identifier for each carrier of the set of carriers; and
receive, via the transceiver, an indication of the respective carrier identifier for the selected carrier, wherein the indication of the respective carrier identifier for the selected carrier indicates which carrier the UE is to select for transmission of the request for the system information.

30. An apparatus for wireless communication, comprising:
memory;
a transceiver; and
at least one processor of a user equipment (UE), the at least one processor coupled with the memory and the transceiver, and the at least one processor configured to cause the apparatus to:
receive, via the transceiver, an indication of a configuration for a flexible cell supported by a base station, wherein the flexible cell comprises a set of carriers comprising an anchor carrier and two or more non-anchor carriers;
select, from among the set of carriers of the flexible cell and based at least in part on the configuration for the flexible cell, a carrier for reception by the UE of an acknowledgement for a request for system information associated with the flexible cell;
transmit, via the transceiver and to the base station, the request for the system information associated with the flexible cell; and
receive, via the transceiver, the acknowledgement for the request for the system information via the selected carrier.
